(19) United States
(12) Patent Application Publication
(10) Pub. No.: US 2014/0324879 A1
(43) Pub. Date: Oct. 30, 2014

(54) CONTENT BASED SEARCH ENGINE FOR PROCESSING UNSTRUCTURED DIGITAL DATA

(71) Applicant: DataFission Corporation, San Jose, CA (US)

(72) Inventors: Harold Trease, Blacksburg, VA (US); Lynn Trease, West Richland, WA (US); Shawn Herrera, San Jose, CA (US)

(73) Assignee: DataFission Corporation, San Jose, CA (US)

(21) Appl. No.: 14/262,756

(22) Filed: Apr. 27, 2014

Related U.S. Application Data
(60) Provisional application No. 61/816,719, filed on Apr. 27, 2013.

(51) Int. Cl. G06F 17/30

(52) U.S. Cl. CPC G06F 17/30864
USPC 707/741; 707/756

(57) ABSTRACT

Systems and methods for receiving and indexing native digital data and generating signature vectors for subsequent storage and searching for such native digital data in a database of digital data are disclosed. Native digital data may be transformed into associated transform data sets. Such transformation may comprise entropy-like transforms and/or spatial frequency transforms. The native and associated transform data sets may then be partitioned in to spectral components and those spectral components may have statistical moments applied to them to create a signature vector. Other systems and methods for processing non-image digital data are disclosed. Non-image digital data may be transformed into an amplitude vs time data set and a spectrogram may then be applied to such data sets. Such transformed data sets may then be processed as described.

### CROSS-REFERENCE TO RELATED APPLICATIONS

This application claims priority to U.S. Provisional Patent Application No. 61/816,719 filed 27 Apr. 2013, which is hereby incorporated by reference in its entirety.

### BACKGROUND

The Digital Universe (DU) may be construed and/or defined to encompass the sum total of all of the world's digital data collected, generated, processed, communicated, and stored. The size and growth rate of the DU continues to increase at an exponential rate with the estimated size of the DU growing to over 40 zettabytes by the year 2020. The bulk of this data consists of “unstructured data”. Unstructured data comes in many forms, including: image, video, audio, communications, network traffic, data from sensors of all kinds (including the Internet of Things and the Web of Things), malware, text, etc.

Unstructured data is typically stored in opaque containers—e.g., such as raw binary, compressed, encrypted, or free form data, as opposed to structured data that fits into row/column formats. It is not only important to know the size and rate of growth of the DU, but also to know the distribution of data which is estimated to be approximately 88% video and image data; 10% communications, sensor, audio, and music data; and 2% text. It is also estimated that only 3-5% of the 2% textual DU is currently indexed and made searchable by major search engines (e.g., Google, Bing, Yahoo, Ask, AOL, etc.).

Internet and Enterprise search engines are the dominant mechanism for accessing stores of DU data to support the major uses that include commerce, business, education, governments, communities and institutions, as well as individuals. Textual search through text-based keywords and metadata tags is by far the most popular method of searching DU data. The above only goes so far since only about 3-5% of the 2% of the (textual) DU is indexed and made searchable. Searching by metadata tags is useful, but because not all unstructured data has metatags associated with it, it may be desirable to have techniques that can handle such unstructured and untagged data.

Usually, manual labor (e.g., crowd sourcing, likes/dislikes, etc.) may be used to generate the tags before they can be used by traditional search engines and databases, which is time consuming, expensive, and has limited coverage. As valuable as textual metadata search technologies have been, having the ability to discover links, connections, and associations within and between data content may be of more value. The creation of social media companies (e.g., Facebook, LinkedIn, Twitter, etc.) are examples of this. An additional use of linking across data sets and types also allows for deep analytics to be applied to the data to extract non-obvious relationship, patterns, and trends (e.g., ads, recommendation engines, business intelligence, metrics, network traffic analysis, etc.). As such, it may be desirable to make the content of the unstructured DU searchable.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Systems and methods for receiving and indexing native digital data and generating signature vectors for subsequent storage and searching for such native digital data in a database of digital data are disclosed. Native digital data may be transformed into associated transform data sets. Such transformation may comprise entropy-like transforms and/or spatial frequency transforms. The native and associated transform data sets may then be partitioned in to spectral components and those spectral components may have statistical moments applied to them to create a signature vector. Other systems and methods for processing non-image digital data are disclosed. Non-image digital data may be transformed into an amplitude vs time data set and a spectrogram may then be applied to such data sets. Such transformed data sets may then be processed as described.

In one embodiment, a system for searching digital data, is disclosed, comprising: an indexing module, said indexing module capable of receiving a native digital data set, said native digital data set comprising a spectral distribution; a signature generation module, said signature generation module capable of generating one or more transform data sets from said native digital data set and generating a signature vector from said native digital data set and one or more transform data sets, said signature vector comprising a spectral decomposition and a statistical decomposition for each of said native digital data set and one or more transform data sets; a TOC database, said TOC database capable of storing said signature vectors; and a searching module, said searching module capable of receiving an input signature vector, said input signature vector representing an object of interest to be searched with said TOC database and return a set of signature vectors that are substantially close to said input signature vector.

In another embodiment, a method for method for generating signature vectors from a native digital data set is disclosed, comprising: receiving a native digital data set; applying an entropy transform to said native digital data set to create an entropy data set; applying a spatial frequency transform to said native digital data set to create a spatial frequency data set; partitioning each of said native digital data set, said entropy data set and said spatial frequency data set into a set of spectral component data sets; and applying a set of statistical moments to said spectral component data sets to create a signature vector for said native digital data set.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is one embodiment of a system as made in accordance with the principles of the present application and an exemplary environment for its operation.

FIG. 2 is one embodiment of an indexing module and its operation in the context of an exemplary environment.

FIG. 3 is one embodiment of a Signature and Table of Content (TOC) module as made in accordance with the principles of the present application.

FIG. 4 is one embodiment of an Entities and Keyword Index Table (KIT) module as made in accordance with the principles of the present application.

FIG. 5 is one embodiment of a Search module and its operation upon a search request by a user.

FIG. 6 is one embodiment of a Search module and its operation in returning search results to a user.

FIG. 7 is one embodiment of a Query By Example module as made in accordance with the principles of the present application.

FIG. 8 is one embodiment of an analysis module and its operation in the context of an exemplary environment.

FIG. 9 is another embodiment of a system as made in accordance with the principles of the present application.

FIG. 10 is a view of several exemplary modules as potentially populating the system as shown in FIG. 9.

FIGS. 11A through 11C depict one embodiment of processing one image data frame.

FIGS. 12A-12C and 13A-13C depict the processing of other image data frames as done in accordance with the principles of the present application.

FIG. 14 is one embodiment of a hierarchy of unstructured data that may be employed to process unstructured data.

FIGS. 15 and 16 are exemplary embodiments of searching for image data within a set of video data.

FIG. 17 is one exemplary embodiment of searching for sound data within a set of audio data.

FIG. 18 is one exemplary embodiment of a high level cluster.

FIGS. 19 through 21 are exemplary embodiments of employing search cone and/or search box constructs to aid in the search process.

FIG. 22 depicts one embodiment as how non-image data sets may be processed by the present system and techniques to generate signatures.

FIG. 23 depicts one embodiment of a native data set being transformed into complementary data sets and processed to generate a high dimensional signature.

FIG. 24 depicts one embodiment of a synthetic ground truth generator as made in accordance with the principles of the present application.

### DETAILED DESCRIPTION

As utilized herein, terms “component,” “system,” “interface,” “module”, and the like are intended to refer to a computer-related entity, either hardware, software (e.g., in execution), and/or firmware. For example, a component can be a process running on a processor, a computer node, computer core, a cluster of computer nodes, an object, an executable, a program, a processor and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

### Introduction

To have any useful results in searching the DU for particular items, ideas and/or themes, it may be desirable to bring some structure and/or order to the DU itself. For example, it may be desirable to employ methods and algorithms that auto-generate the metadata tags to unstructured and untagged data based on the content of the data. Thus, various aspects disclosed herein describe embodiments of the process, system, and/or methods used to generate computer-readable code and computer interfaces for ingesting, indexing, searching, linking, and/or analyzing stores of unstructured data. One embodiment may employ modules and algorithms comprising: (1) being able to generate unique signatures (e.g., digital fingerprints) of the information content of unstructured data and (2) being able to compare signatures to determine a metric distance in a high-dimensional information space—thereby determining how related or unrelated two entities are. Building upon these algorithms, methods for searching, linking, and analyzing unstructured data may be used to build a process and system for: (1) Indexing unstructured data into searchable index tables, (2) Searching unstructured data, (3) Linking/Associating unstructured data, (4) Building deep analytic engines for unstructured data, and (5) Generalized editing.

In several possible embodiments disclosed herein, instantiating these methods into computer-readable code along with data management, parallel/transactional computing, and parallel computing hardware may provide a basis for building an unstructured database processing “server”. In addition, the server may employ a mechanism for communicating with users and other machines, so a “client” interface may be defined to handle user-to-machine communication and machine-to-machine communication. In several embodiments, combining these together may provide a basis of a platform (or framework) for: (1) Building a generalized unstructured data search engine, (2) Building social network engine for discovering links discovered within and across unstructured data (e.g., particularly image, video, and audio), (3) Building deep analytics applications for processing unstructured data, and (4) Building a generalized editing application for adding, deleting, replacing signals and/or patterns representing features and/or objects.

While many of the embodiments disclosed and discussed herein are made in the context of a client/server model of computation, communication and data flow, it will be appreciated that the methods and techniques that are herein disclosed and described will work in many other computing environments. For example, the ingestion, indexing, searching and linking may be performed on a single stand-alone computer and/or computing system—or in a network (e.g., distributed, parallel or others) of such computers. Other computing environments are possible for hosting and/or executing the methods and techniques of the present application—and that the client/server model is merely one of the many models that are encompassed by the scope of the present application.

### One Embodiment

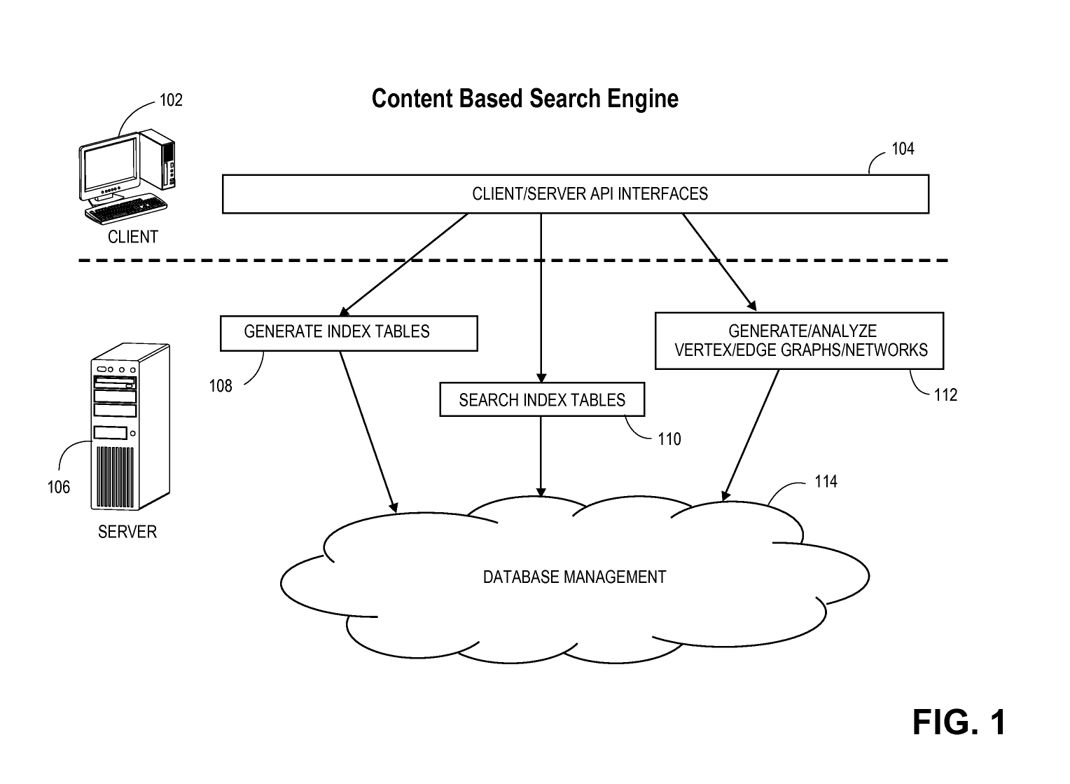

FIG. 1 depicts one possible embodiment of a suitable architecture as made in accordance with the principles of the present application. As may be seen, server 106, under control of many modules and techniques described herein, may be able to communicate with one or many clients 102 via APIs 104 to perform tasks such as—e.g., generate index tables 108, search index tables 110 and/or generate/analyze graphs and/or networks 112.

The following is a brief description of some of the modules and/or processes that might be employed by such a suitable architecture:

Data Ingest: Data may be ingested from any real-time digital streams, archived data stored on storage media, IP connected device, and mobile/wireless device. Data may also be ingested from analog devices by running it through an analog-to-digital converter. Examples of ingestible data includes, but is not limited to, image, video, text, audio, and network traffic.

Signature generation: Ingested data is divided into data frames either through natural subdivision or an artificial subdivision definition. Data frames are transformed into signatures using multivariate statistics and information theoretic measures and are store into searchable databases. Signatures of hierarchical sub-frame entities, by recursively subdividing data frames, are generated and stored into databases. A database entry for a data frame consists of a name, signature, metadata pointer back into the original data, and any metadata about the original data are stored into databases. Metadata about the original data may include, but is not limited to, author, ingest time/date, spatial data (latitude/longitude), and descriptive data size (frame rate, frame size, sample rate, compression scheme etc.).

Unstructured Data Indexing: Data summarization tables, called the table-of-contents, are created using algorithms that sequentially scan the signatures to determine discontinuities based on variations of information content. Based on these discontinuities, each table-of-contents entry represents a segment, which is a run of data frames with similar information content. A table-of-contents segment entry consists of the average signature of the segment, pointer to the start of the segment, pointer to end of the segment, length of the segment, path pointer back into the original data, and an icon for the segment. The segment data is store into the database. Signatures of hierarchical sub-frame entities, by recursively subdividing table-of-contents data frames, are generated and stored into databases. A database entry for a frame consists of a name, signature, a metadata pointer which points back into the original data (e.g., file path, URI, URL, etc.), and any metadata about the original data are stored into databases. As referred to below these index and summarization tables may be used to form the basis of data reduction and data compression algorithms.

Unstructured Search Method: The search algorithm is based on a query-by-example paradigm, where signature comparison algorithms compare the signatures of search criteria against stored database(s) of signature data and return an ordered list of results. This ordered list may then be ranked using various default or directed criteria. The ordered list of results may also be passed on to other algorithms which re-order, re-rank and re-sort them based on other default or directed criteria.

Unstructured Search Criteria: The search query, called the search criteria, is an example of the signature of what is being searched for against the signature of what has been indexed and stored into the database(s). Examples of search criteria are, but not limited to signatures of, image, cropped images, sub-images, video clips, audio clips, text strings, binary files, and network data. Search criteria may consist of compound search criteria connected by boolean operators, logical operators, and/or conditional operators such as, but not limited to, and/or/not, greater than, less than, etc. The unstructured data representing the search criteria is ingested and signature(s) are generated and stored into a database which will be recalled and referred to by the subsequent search algorithms steps and phases.

Unstructured search method and algorithm: The database(s) to be searched may range from, but not limited to, all or a selected subset of indexed databases. The signature of the search criteria is compared against a subset of signatures from the indexed and selected database(s) which results in an ordered set of pair-wise distance measures and reverse pointers to paths back into the database. This ordered set of signatures are returned and are then ranked or passed on to subsequent processing algorithms which rank the results.

Linked Edge Graph (the keyword to entity to frame edge graph): A link is defined by two (signature) vertices, in a high-dimensional information space, with a connecting edge between them. A database of links between frames and entities are generated by binning the signatures of frames and sub-frame entities into an inverted index table. Each bin of the inverted index table contains a set of sub-frame entities which have similar information content defined to high-dimensional distance measures. Bin definitions may overlap and entities may be contained in multiple bins. The signatures of each bin are averaged and the entity whose signature is closest to the average within the bin is identified as the keyword for the bin. Links are defined to connect keywords-to-entities-to-frames. Keyword signatures may be combined into databases called keyword signature dictionaries and used to define a basis set for the signature data. The collection of links may be formed into a graph (or network) which represents the connectedness of the signature data, and the objects they represent. Link associations between entities, keywords, frames, and data sources (e.g., images, videos, audio, communications etc.) are identified and/or discovered using a graph search engine and graph analytics algorithms to analyze this edge graph.

Social network: Metadata may be attached to the linked edge graph to define a social network or social graph. Examples of metadata may include, but is not limited to, people names, place names, spatial data (e.g., latitude/longitude), and other descriptive metadata.

Data reduction/compression: The combination of the signatures data structures and databases associated with the indexing, summarization, and linked edge graph algorithms represent a data reduction strategy. By reverse indexing of keywords and sub-frame entities into frames, either lossy or lossless data reconstruction algorithms may be generated.

Interfaces: Client/Server web communication is provided through a web server, by embedding web service calls in another application, through a mobile web interface or through external applications. The interface for the indexing process allows the user to input the file(s) to upload from either the client or from the server and from the file name(s) or from a file containing a list of the file names. Indexes are stored in a database by the name given, unless it is not a valid Linux name; in which case the name will be adjusted so it is valid.

In addition to image and video files, the user may specify audio files and all source files to upload and index. The user may also specify the start and end time, a specific size to cut the frame into, to keep the original file or not, the number of processors, and other options or parameters. The segments for the Table-of-Contents may be viewed or received through an XML response. The interface for the search process allows the user to select the image(s) from the database to search for and to select the media file(s) from the database to search within. These searches may be done with multiple images and multiple media files. They may search one media database, several, or all databases. The Boolean operators or, and, not, and any combination of these may be used in the search. The user may also specify the number of results to return, the number of processors, and other options or parameters. A batch search allows the user to submit a search in a batch mode. The results for the search may be viewed or received through an XML response. The results may be sorted by their rank, frame number, or time segment.

Other interface options include the ability to cut out an image with any size and rotate it, to extract specific frames from a video, play a video or video segment, display metadata about the video, enlarge an image, a login with password, ability to manage databases by creating databases, renaming databases and files, moving files, deleting databases and files, displaying the job status, and ability to cancel jobs.

Parallel computing: The indexing process makes use of parallel, distributed/shared parallel compute, memory, and communication hardware and parallelized algorithms. The search process and graph analysis makes use of <key, value> pairs, transaction-based parallel computing hardware, and algorithms for performing pair-wise distance comparisons.

Database management: Database management for index, search, and graph analysis makes use of SQL and NoSQL databases for storing and manipulating signature data and metadata.

Applications: Many applications of unstructured search and social network analysis are possible. The following list contains an example list of possible applications, but is not limited to:

(1) Content-based unstructured data search engine: Search for anything.

(2) Content-based unstructured data social network engine: Connect and associate all data. Graph search.

(3) Deep analytics of unstructured data (serving ads, business intelligence).

(4) Product search: Consumers can't buy what they can't find.

(5) IPTV search: Viewers can't watch TV shows that they can't find.

(6) Sports search: Find a favorite player, combination of players, or a player performing a specified activity (such as scoring a touchdown, basket, or hitting a home run).

(7) Digital Rights Management: Find watermarks, content violations, copyright violations, etc.

(8) Surveillance: Finding people, vehicles, places, activities, events in aerial, terrestrial audio/video/network surveillance.

(9) Patterns-of-Life: By analyzing geometric patterns and structure within the high-dimensional information-based search space, with attached metadata, to classify and/or identify activities and events.

(10) Digital Data Editor: Search and replace functions within unstructured data streams, archives, and files. For example: (1) Searching for signatures of artifacts in digital video and replacing these artifacts in either the foreground and/or background; and/or (2) Searching for unknown patterns of malware (like viruses) and deleting/replacing them. This would be accomplished automatically through keyword replacement by searching for digital keyword patterns and replacing what was found by other digital keyword(s).

### Table of Commonly-Used Terms

To aid in reading and understanding several of the concepts described herein, the following is a table of commonly-used acronyms and their associated meaning to aid the reader when such acronyms are used. It will be appreciated that these acronyms are not meant to limit the scope of the present invention—but are given as may be employed to describe various embodiments of the present invention. Where other entities, objects and/or meanings are possible, the scope of the present invention encompasses them.

TABLE 1
Acronym Table

| DU | DU: Digital Universe - All things digital | |
|---|---|---|
| Entity | Entity: An entity may be a “dope vector” | |
| | An entity may be a “dope vector” which may be a mini-data | |
| | structure containing: 1) The (information content) signature | |
| | feature vector of the data pointed to by the keyword, 2) | |
| | Metadata about the keyword (e.g. path to the source | |
| | frame/image, where/geometry in the frame/image the | |
| | keyword may be located, etc.). The indexing process may | |
| | break down images/videos by hierarchically decomposes | |
| | document files (i.e., images and videos) using a sliding | |
| | overlapping spatial/temporal window. Entities may be whole | |
| | scenes, (cropped) faces, noses, cheeks, eyeballs, eyebrows, | |
| | teeth, ears, swatches of hair, ears, ear lobes, audio signals, | |
| | computer malware, computer virus, non-image digital data | |
| | etc. | |
| FFMPEG | Third Party Open source video and image ingest and | |
| | decoding/encoding library. Coded in C, but has both C and | |
| | C++ library bindings. | |
| GMV | General Mesh Viewer software - a third party utility for | |
| | visualizing image and video data. | |
| HDP | HDP: High-Dimensional Projection | |
| | The process of projecting high-dimensional feature vector | |
| | data into lower-dimensional space for visualization purposes. | |
| HHMM | HHMM: Hierarchical Hidden Markov Model | |
| | Hierarchical Hidden Markov Model used to abstract the raw | |
| | data into signatures. May be a machine learning algorithm. | |
| ImageMagick | Third party open source image decoding library. Coded in | |
| | C++, but has both C and C++ library bindings. | |
| Indexing | Indexing: Transforms ingested image/video media data into | |
| | signatures | |
| | The Indexing process transforms ingested image/video media | |
| | data into two primary data structures: One may be called the | |
| | Table-Of-Contents (TOC) and the other may be called the | |
| | Keyword-Index-Table (KIT). These two data structures may be | |
| | created by one single sweep through the ingested data. After | |
| | the TOC and KIT may be generated then the original media | |
| | data may be discarded. | |
| Keyword | Keyword: A keyword may be a “dope vector - Unique entity | |
| | Keyword in this case probably should be called a “visual” | |
| | keyword and represents a (cropped)face, face in a scene, etc. | |
| | A keyword may be a “dope vector” which may be a mini-data | |
| | structure containing: 1) The (information content) signature | |
| | feature vector of the data pointed to by the keyword, 2) | |
| | Metadata about the keyword (e.g. path to the source | |
| | frame/image, where the geometry in the frame/image for the | |
| | keyword may be located, etc.). Basically, a keyword | |
| | represents a truncated, high-dimensional cone in the search | |
| | space, where the entities associated with each keyword may | |
| | be the entities which have (coordinate) signatures contained | |
| | inside the keyword-cone. | |
| KIT | KIT: Keyword-Index-Table | |
| | The KIT may be one of the primary data structures stored in | |
| | the SiDb database. The structure of the KIT looks a lot (in | |
| | structure) like the index table in the back of a typical book | |
| | which cross-references keywords and their location through | |
| | the document(s), where the most left-hand entry may be | |
| | called a “keyword” and column entries may be called | |
| | “entities”. The KIT may be an inverted index table, also | |
| | referred to as a Sparse Representation Dictionary, created by | |
| | the indexing process using Sparse Representation algorithms. | |
| | The size of the KIT (i.e., number of entries and storage | |
| | requirements) scale according to the amount of unique | |
| | information content (e.g., number of subjects) contained in | |
| | the media, not the volume of the media or the number of | |
| | images/frames of subjects. | |
| | Generating the KIT: Indexing hierarchically decomposes | |
| | document files (i.e., images and videos) using a sliding | |
| | overlapping spatial/temporal window, where each window | |
| | may be referred to as an “entity”. This emits a data structure | |
| | of “documents pointing to entities” which may be stored in a | |
| | NoSQL database. When this data structure may be “inverted”, | |
| | to generate an inverted index table, it emits a new data | |
| | structure of “entities pointing back into documents”. Entities | |
| | may be filtered into a set of “unique” entities, called | |
| | keywords, by “binning” the entities; where a keyword | |
| | represents a “bin” of entities. Basically, a keyword represents | |
| | a truncated, high-dimensional cone in the search space, | |
| | where the entities associated with each keyword may be the | |
| | entities which have (coordinate) signatures contained inside | |
| | the keyword-cone. Each keyword may be a row in the KIT | |
| | matrix, where the column entries on each row may be the | |
| | entities contained in the keyword-cone. The keyword of the | |
| | KIT may be the most average (signature) entity along the row. | |
| | It requires an iterative algorithm to achieve the optimal KIT. | |
| | If all of the keywords/entities from the KIT may be assembled, | |
| | into a multidimensional-vector (keywords) or matrix | |
| | (keywords/entities), they form the semi-orthogonal | |
| | information basis vector that spans the media dataset, where | |
| | the information content of the original dataset may be | |
| | reconstructed from the KIT. The basis vector may be semi- | |
| | orthogonal because the bins used to generate the KIT may | |
| | overlap (Note: This may be a user adjustable parameter). | |
| QBE | QBE: Query-by-Example | |
| | The example may be the exemplar being searched for (e.g., | |
| | the image, cropped image, video clip, audio clip, malware | |
| | etc.). | |
| RSEC | RSEC: Recognition Search Engine Component | |
| | May use recognition search technology to re-rank the results | |
| | of Similarity Search Engine Component (SSEC). SURF/SIFT | |
| | algorithms may be used to perform its (optional) recognition | |
| | search, but other more traditional recognition engines could | |
| | be inserted. The execution of the RSEC may be optional | |
| | because it may be the second stage of a two stage search | |
| | process. Similarity search using the SSEC may be the first | |
| | stage in the search pipeline and produces a SERP. This ranked | |
| | list of SSEC search results may either be returned to the | |
| | user/analyst as a SERP or optionally passed onto the RSEC | |
| | recognition search, which will re-rank the search results. The | |
| | (search) results from the RSEC may be returned to the | |
| | user/analyst as a Search Engine Result Page (SERP). | |
| SSEC | SSEC: Similarity Search Engine Component | |
| | Uses similarity metrics to compare feature vector signature | |
| | components. The search space representation may be a high- | |
| | dimensional coordinate space into which signatures may be | |
| | projected. The SSEC uses pair-wise signature comparison | |
| | metrics defined as high-dimensional distance (e.g., Specular | |
| | Angle, L-1, or L-2) metrics to generate a similarity metric. The | |
| | (search) results from the SSEC may either be feed into the | |
| | recognition search engine component (RSEC) or returned to | |
| | the user/analyst as a Search Engine Result Page (SERP). | |
| Search Space | SSR: Search Space Representation | |
| Representation | The search space representation may be made up of | |
| | databases containing the search space signatures (i.e., TOC | |
| | and KIT databases) stored in NoSQL databases, with metadata | |
| | about the TOC/KIT signatures stored in a SQL database. The | |
| | search space representation captures the information content | |
| | of the media data into a high-dimensional space using feature | |
| | vector signatures. Signatures may be mathematical | |
| | representations of the quantitative information content and | |
| | form the basis of the search engine which | |
| | generates/compares signatures. | |
| SERP | SERP: Search Engine Results Page (similar to the Google | |
| | results page) | |
| | A SERP may be an HTML5 formatted Webpage containing a | |
| | summary of results. These results provides an analyst with | |
| | cues as to whether what may be searching for may be in the | |
| | database and provides pointers back into the original media | |
| | data to where they may find more information. The SERP | |
| | results may be in the form of sorted, ranked lists containing | |
| | images, sub-images (called “chipouts”, keywords, entities), | |
| | frames. SERPs also provide metadata pointing into the raw | |
| | data (Note: Because the search engine uses an abstracted | |
| | search space representation the raw data may or may not be | |
| | physically present or available, but the pointers may be | |
| | provided anyway just in case they may be useful to the | |
| | analyst.) | |
| | SERPs may also be returned in a machine-to-machine fashion | |
| | using what may be called a RESTful interface | |
| | (Representational State Transfer) model. In these cases the | |
| | SERPs may be formatted as XML results and “posted” to the | |
| | client. | |
| STGT | SGTG: Synthetic Ground Truth Generator | |
| | The SGTG may be used as an offensive/defensive component. | |
| | The SGTG may synthetically inject exemplar search data (e.g., | |
| | images, cropped images, video clips, audio clips, malware, | |
| | etc.) to create modified input data, which is ingested and | |
| | indexed into the search space of the search engine platform. | |
| | The SGTG may then launch QBE searches to find the data that | |
| | was injected into the data. The SGTG may then compare | |
| | search results against the data that was injected by the SGTG | |
| | and a list of quality and accuracy metrics may be created. The | |
| | synthetic injected data may be modified (e.g., distorted, | |
| | made fuzzy/noisy, etc.), which may allow the SGTG to explore | |
| | the attributed and parameters associated with search space. | |
| | This iteration between inject, ingest, index, search, and | |
| | evaluate may be automated to cover all possible data | |
| | conditions/scenarios. | |
| Signature | Signature: High-dimensional feature vector that quantifies | |
| | information content | |
| | Multivariate statistical measures used to discriminate one | |
| | piece of information from another. If you can generate | |
| | signatures and compare signatures, then you can build a | |
| | search engine. | |
| | 1. | Signatures may be used to quantify and compare the |
| | | “information content” of raw media data. The |
| | | “information content” of data may be captured in high- |
| | | dimensional signature feature vector form by using |
| | | multivariate statistical analysis of: 1) The raw media |
| | | data; 2) The media data transformed using Shannon |
| | | Information Theory and Entropy; and spatial moments |
| | | (edges, curvature, and corners) of the raw media data. |
| | 2. | Signatures may be N-dimensional feature vectors |
| | | projected into a high-dimensional space and occupy a |
| | | position in that N-dimensional space. The space defines |
| | | the search space representation. |
| | 3. | Sets of signatures may be clustered, searched, linked, |
| | | etc. |
| | 4. | Signatures (in general) may be lossy. |

| | |
|---|---|
| SiDb | SiDb: Signature Database |
| | The SiDb may comprise the TOC and KIT, which may be stored |
| | in database files and/or NoSQL databases, plus metadata |
| | about the data that may be stored in a MySQL database (e.g., |
| | path to original media data, frame count, resolution, ingest |
| | time/date, user that ingested the data, geospatial data |
| | (lat/long) [if available]). Once created, the SiDb may be |
| | transported, communicated, compressed independent of the |
| | original media data. The search engine platform may use the |
| | SiDb to support its search engine. |
| SR | SR: Sparse Representations |
| | An adaptive machine learning algorithms for pattern |
| | recognition. Used to create Sparse Representation |
| | Dictionaries which may be basically KITs. |
| TOC | TOC: Table-Of-Contents |
| | The TOC may be a temporal summarization of the media data. |
| | The TOC may be created by the search engine platform |
| | indexing process and may be one of the two primary data |
| | structures that compose the search space representation to |
| | support the search engine (the second primary data structure |
| | may be the KIT). The TOC summarizes the unique |
| | spatial/temporal information content of the media using |
| | algorithms to filter and compare signatures. The KIT may be |
| | built from the TOC entries. |
| TRL | TRL: Technology Readiness Level |
| | TRL 1 = Idea; 2, 3 = Prototype, 4 = Demonstration in a lab |
| | environment with client data; 5 = Demonstration in a client |
| | space with client data; 5-6 the transition from research to |
| | operations; 7-9 may be operational capability; 9 may be |
| | battlefield, mission critical technology. |

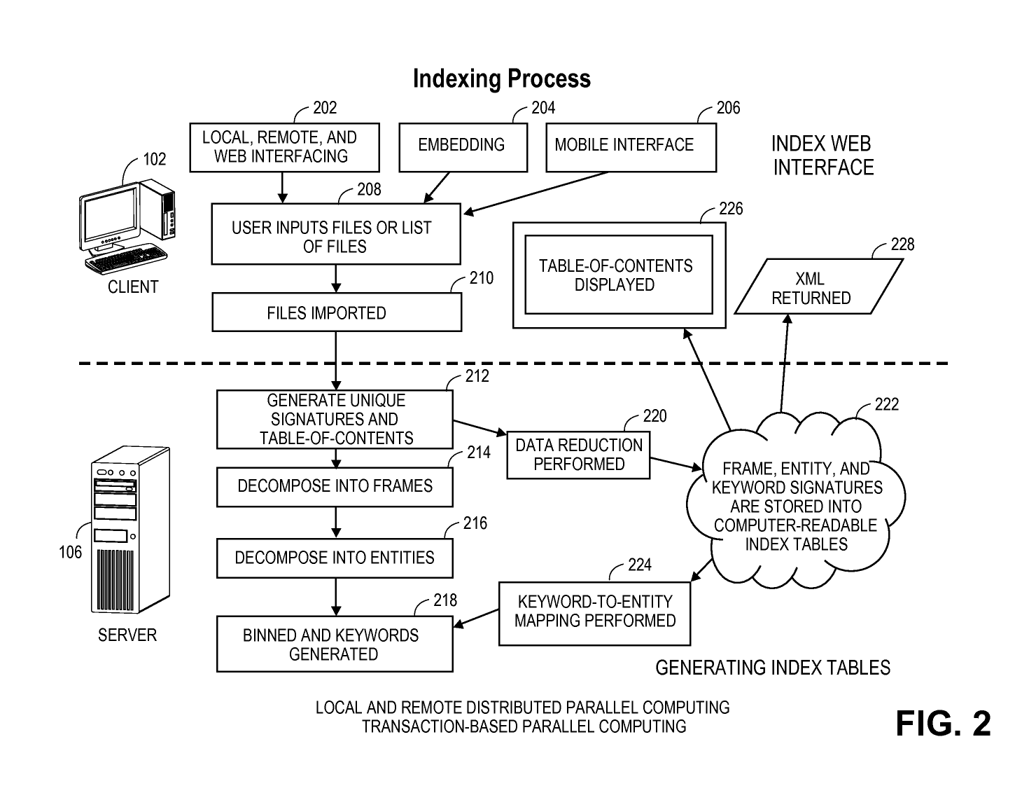

Continuing with describing one possible embodiment of the present system, FIGS. 2 through 4 describe several modules and/or processes that a suitable system may employ.

### One Indexing Embodiment

FIG. 2, as shown, describes one possible indexing module/process. As may be seen, a client (and/or stand-alone user) may commence an indexing process of unstructured data by importing files (210) compiled as files and/or lists of files (208) which may be compiled from various interfaces (local, remote, web, etc.) (202), embedded data (204) and/or mobile or other interfaces (206). In addition, a Table of Contents may be displayed (226) and XML may be returned (228).

At the server (and/or stand-alone controller(s)), the server/controller may generate unique signatures and a Table of Contents (TOC) (212); decompose digital data into data frames (or any other suitable grouping) (214); decompose (or otherwise, organize) data into entities (216); entities may be binned and keywords may be generated (218); data reduction may be performed (220)—e.g., when signatures and TOC are generated, data decomposed or binned. At various steps, frames, entities, keywords, signatures and other data may be stored in a database and/or computer readable index tables (222). In addition, a mapping of keywords to entities may be performed and stored (224).

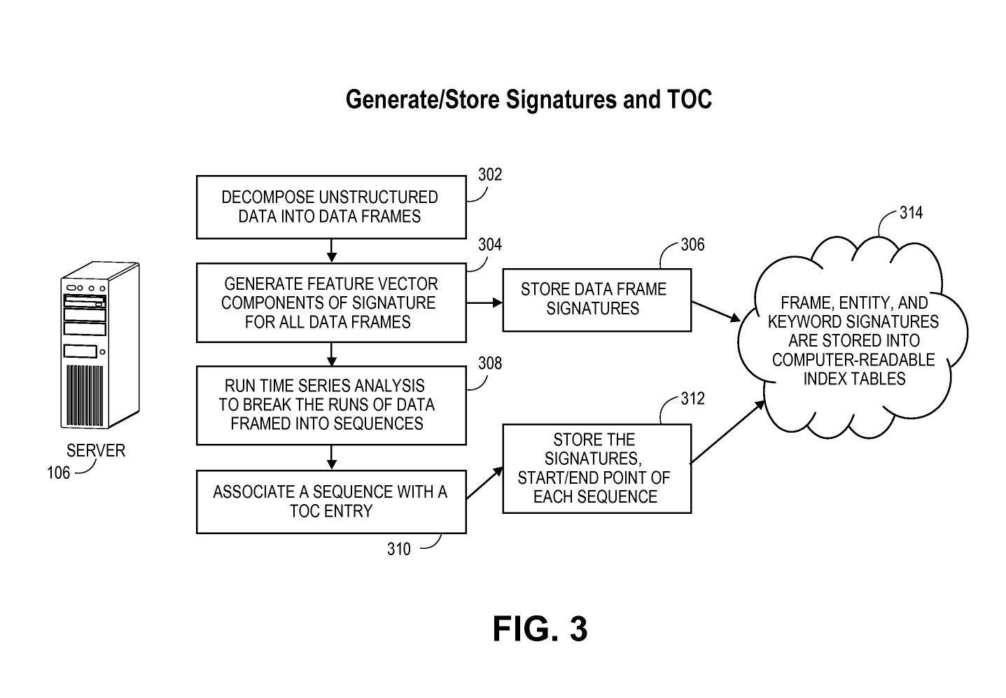

FIG. 3 depicts one embodiment of a module that generates signatures and TOCs and stores them appropriately. At 302, the server/controller may take input unstructured data and decompose them into data frames. In one embodiment, such data frames may be appropriate for the type of data being input. For example, if the data is video, the data frames may be individual image frames comprising the video data. Similar data framing may be applied to different types of unstructured data (e.g., audio, text, raw binary data files, etc.). In another embodiment, server/controller may make some decision and/or interpretation as to how to frame the unstructured data.

At 304, server/controller may generate feature vector components of the signature for each data frame. Such data frame signatures may be stored at 306 into computer readable index tables or database 314. At 308, server/controller may perform an analysis to break the runs of signatures of data frames into sequences—such analysis may be a run-time series analysis.

In one embodiment, an algorithm for identifying demarcations (i.e., the beginning and the end) of a sequence may be identified by comparing a signature at a given point to the running average signature for the run. A demarcation for a sequence may be defined when the distance metric is computed (at e.g., at 706) and the metric distance between given signature and the running average exceeds a defined threshold, where the threshold may be an input variable. The TOC database entry for the sequence may comprise the signatures for the beginning, end, the most average sequence frame, and the heartbeat frames; plus the metadata denoting data frame numbers and time associated with the beginning, end, most average data frame, and the heartbeat frames. The most average data frame may be identified as the signature of the sequence with a distance metric which is substantially closest to the average signature of the sequence. Heartbeat data frames may be frames selected at regular intervals, where the interval is an input variable. At 310, server/controller may associate a sequence with a give TOC entry—and, at 312, server/controller may store the signatures, the start/end points of each sequence into the index tables and/or databases.

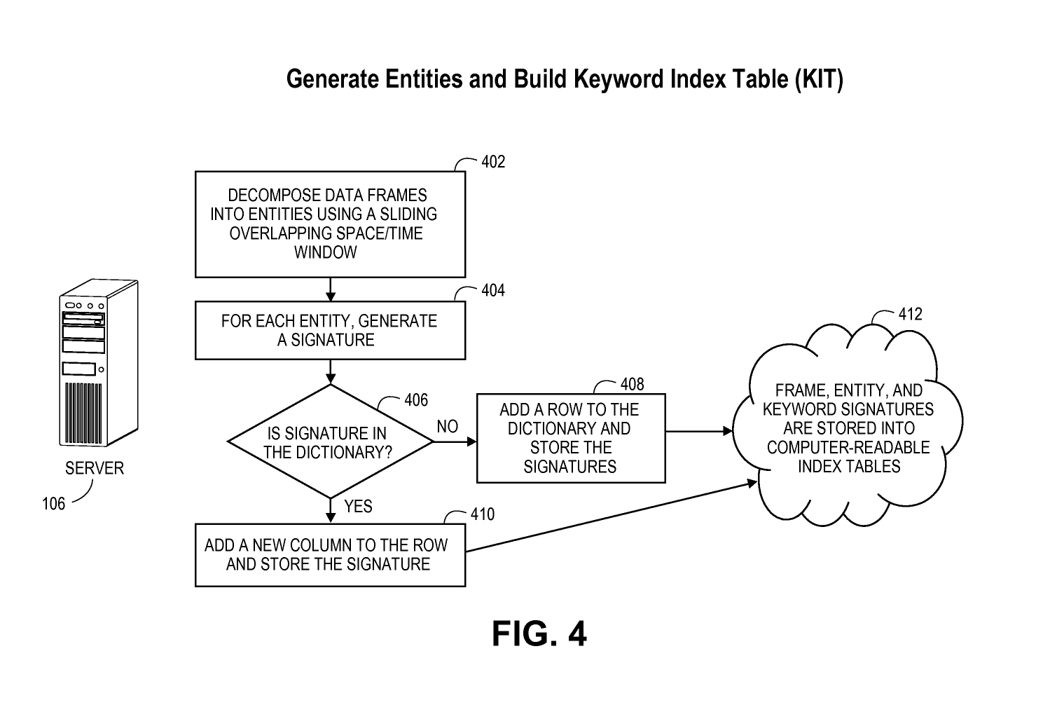

FIG. 4 depicts a module that may generate entities and build a Keyword Index Table (KIT). Server/controller, at 402, may decompose data frames into entities in any suitable manner—e.g., possibly by using a sliding, overlapping window that may represent space, time or a combination thereof. For each entity, server/controller may generate a signature at 404. At 406, server/controller may query as to whether the signature is in the dictionary—and if so, may add a new column to the row and store the signature at 410. Otherwise, a row may be added to the dictionary and the signature may be stored in index table/database 412 at step 408.

### One Searching Embodiment

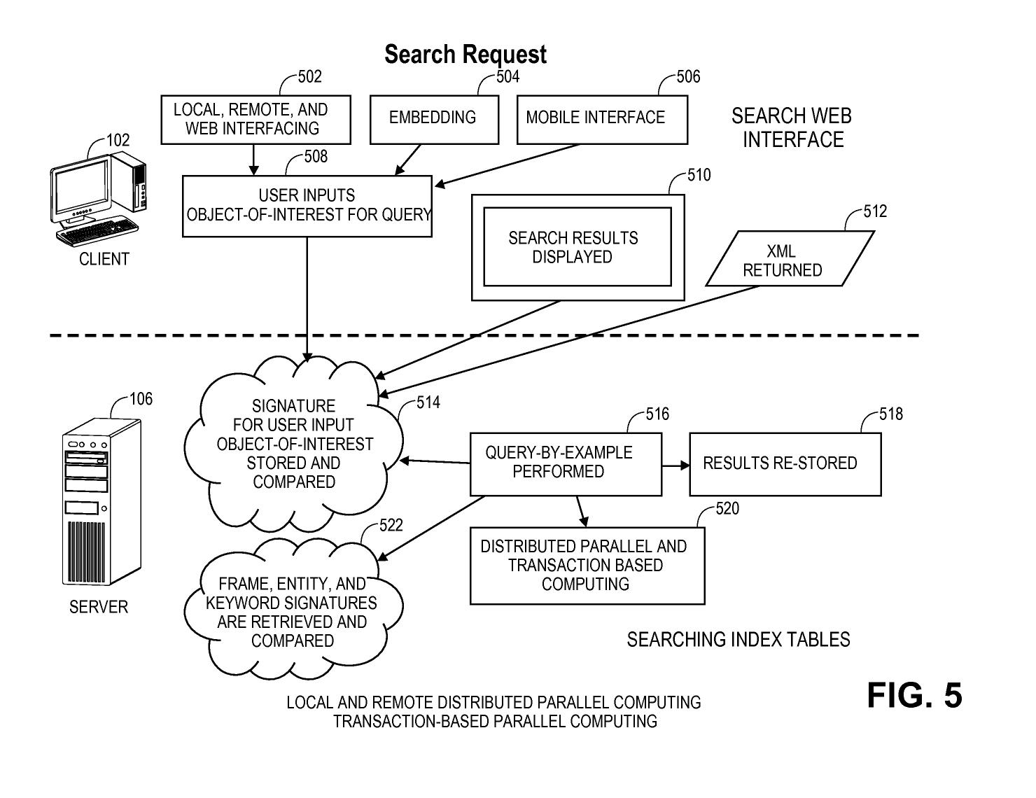

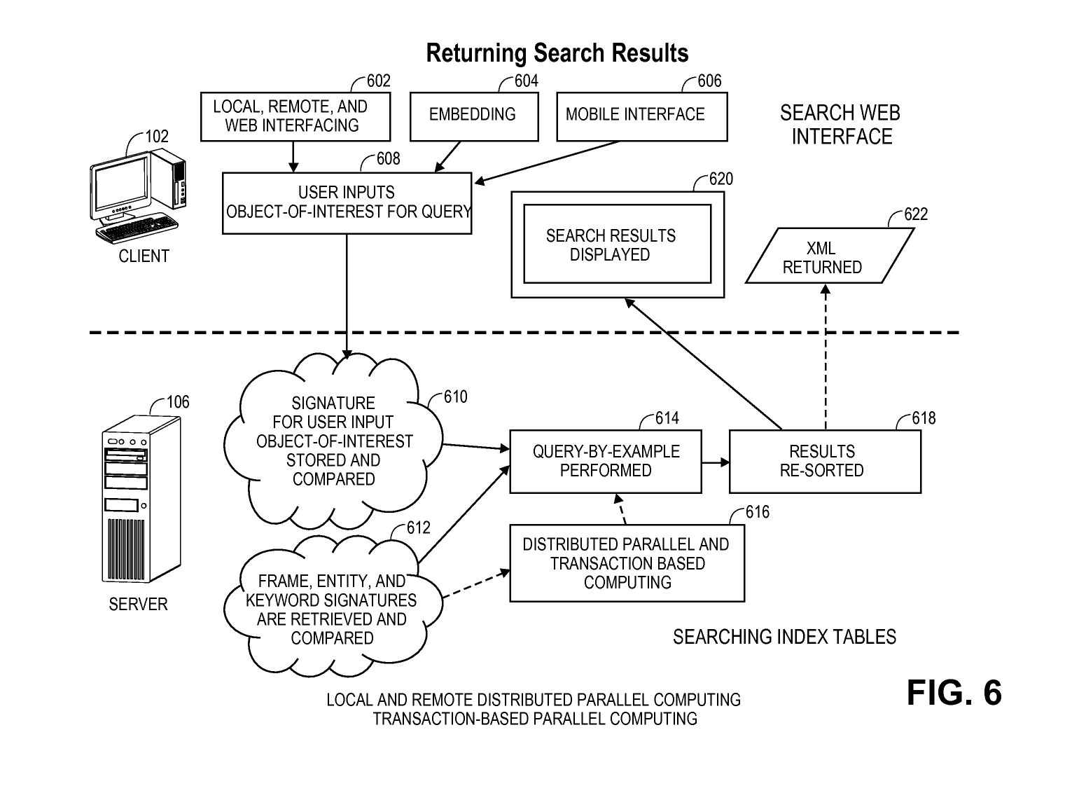

FIGS. 5 and 6 depict one embodiment whereby a user/client makes a request for a search and where the controller/server returns the results of such a search. As before, user/client may input objects of interest to be searched 508/608 in a number of different way—e.g., various interfacing 502/602, embedding 504/604, and/or mobile interfacing 506/606 to the controller/server at 514/614. Any previous search results displayed 510 or XML data returned 512 may be shared with controller/server at 514.

At 514, controller/server may generate or otherwise obtain the signature for the object of interest and frames, entities and keyword signatures may be retrieved and compared at 522. This comparison may be performed and/or enhanced by a search module—e.g., query by example (QBE) at 516. This processing may be processed on a stand-alone controller—or may be shared in a distributed, parallel or transaction-based computer environment at 520. The results of this search may be re-stored at 518.

When the processing is completed, the search results may be shared and displayed back to the user/client at 620 and XML may be returned at 622.

Query By Example (QBE) Module

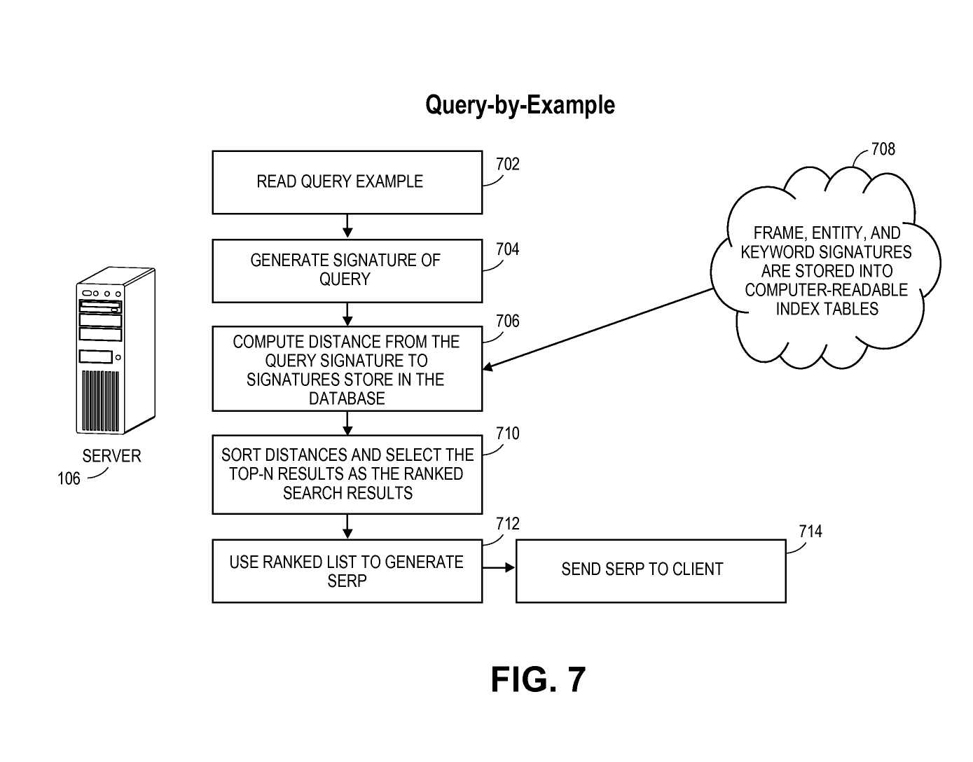

FIG. 7 depicts one embodiment of a Query By Example (QBE) module that may be performed by a server/controller. At 702, server/controller may read the query example that is supplied by the user/client or is supplied by another source or module. Server/controller may take that example and generate a signature of that query example at 704. A distance may be computed at 706 from the query signature to other signatures that are stored in the database and/or index tables 708.

From these distances, server/controller may sort these distances and select the top “N” results and return the ranked search results at 710, where “N” is an input parameter. This ranked list may be used to generate a Search Engine Results Page (SERP) as an easily digestible form of data for the user—which may then be sent to user/client at 714.

Link and Social Network Analysis

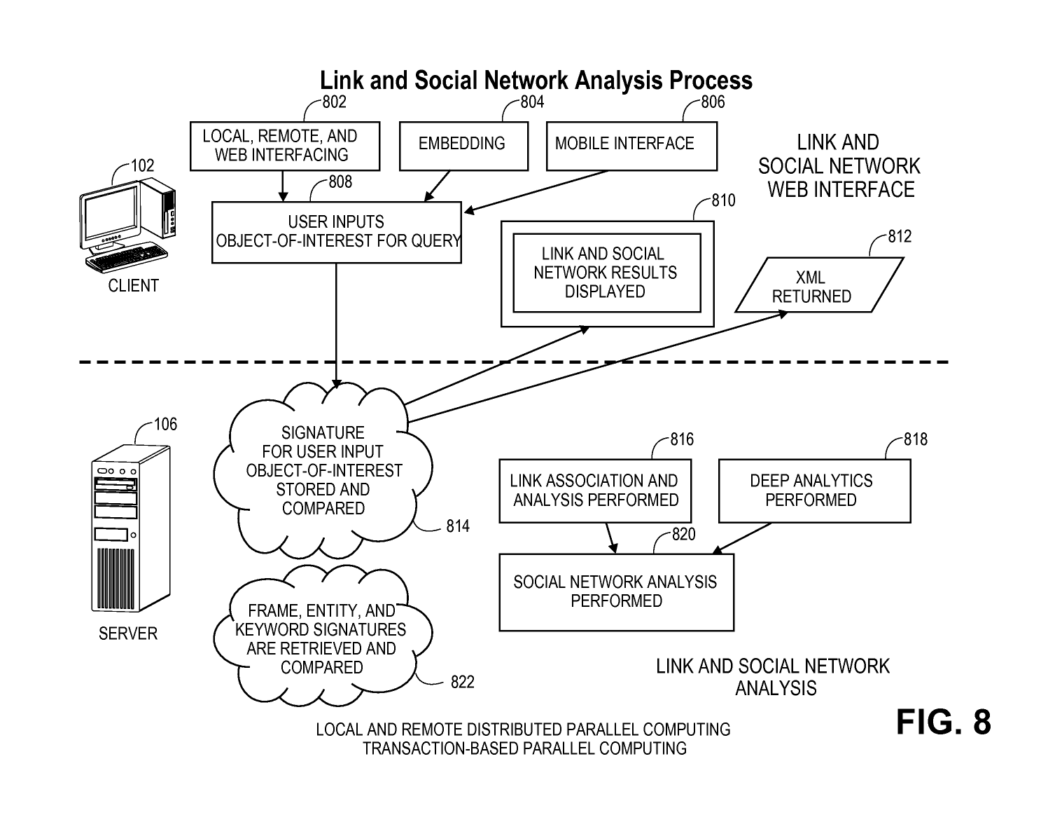

To round out the general architecture and operation of a system as made in accordance with the principles of the present application, FIG. 8 depicts one additional processing module that may be performed by the server/controller—namely, performing deep analytics on links and social networks. As before, a user/client may request analysis on links and social networks via a plurality of interfaces (e.g., 802, 804 and 806). These may comprise a set of objects of interest that may be input by user/client at 808. In addition, any results of link/social networks analysis previously displayed (810) and XML returned (812) may be also input to server/controller.

At 814, a signature of the various inputs for the object of interest may be generated and/or stored and compared—e.g., with frames, entities and keyword signatures, which may also be retrieved and compared at 822. Link association and analysis may be performed at 816—as well as deep analytics at 818. These may be input to comprise an analysis of social networks that may be performed at 820 by the server/controller.

### Another Embodiment

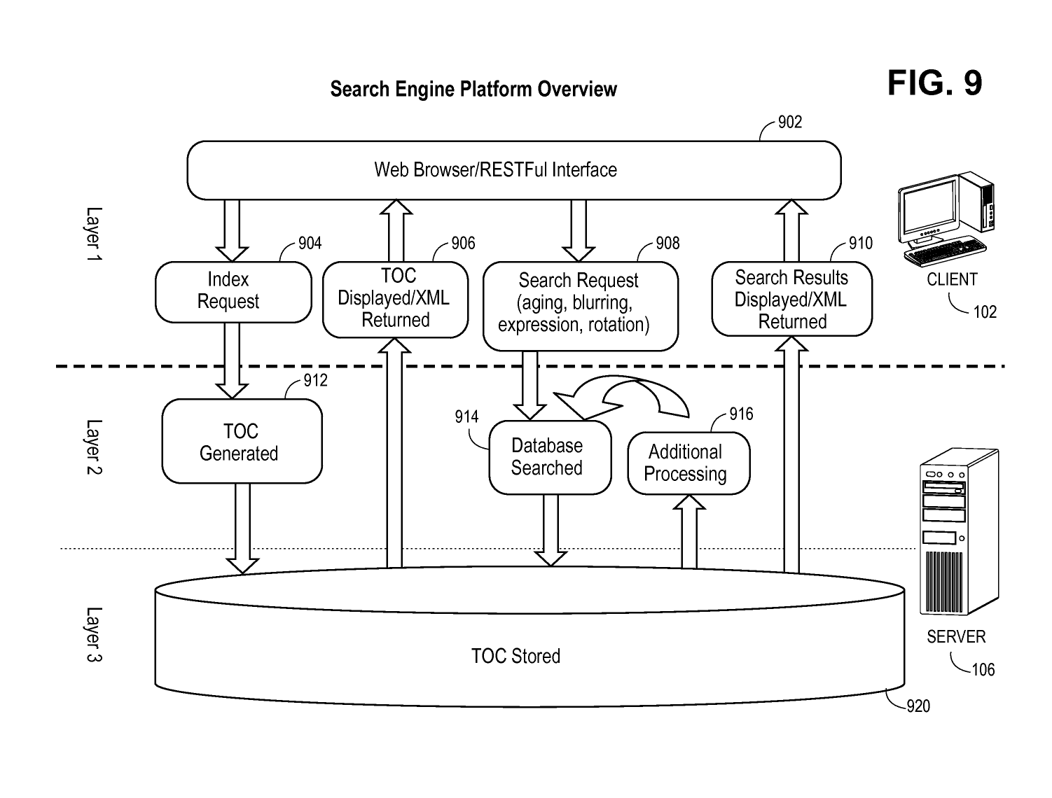

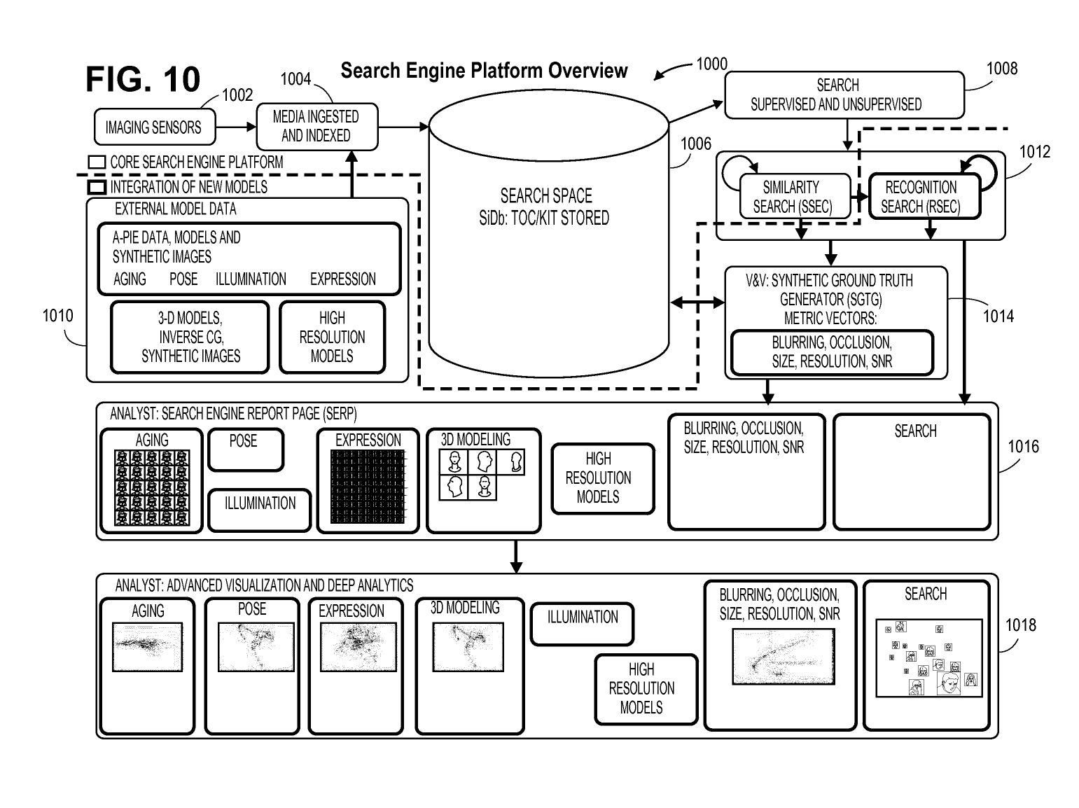

FIGS. 9 and 10 depict another embodiment of a system and set of modules that may be suitable for the purposes of the present application.

FIG. 9 depicts a high level architectural embodiment of one possible suitable system. As may be seen, the platform is depicted as a client/server model of processing. It will be appreciated that many other models of processing are possible and contemplated under the scope of this present application. For example, as in the discussion above, instead of a client/server model, alternative embodiments may include a stand-alone controller and/or processor, a distributed controllers and/or processors, parallel controllers and/or processors—in any manner of providing searching possible.

In continued reference to the embodiment of FIG. 9, users/clients may access the searching and/or analytic processing as described herein via a set of interfaces 902—e.g., web browsers, RESTFul interface and the like. Processing flow may be performed as shown (or in any other suitable manner). Users/clients may request an index of certain data—e.g., structured data, unstructured data, video, image, audio, text or the like. Server/controller may generate a TOC 912 (as described herein) and store the TOC in a set of index tables and/or database 920. The TOC may be displayed back to the user/client 906. With the search properly formulated, the database may be searched (914). Additional processing (as described herein) may also be applied (916). When completed, the search results may be returned to the user/client (910).

In reference to the embodiment of FIG. 10, users/clients may inject externally generated model data (e.g., aging, blurring, expression, 3-D models and the like) into the search space SiDb 1006 using the media ingest and indexing 1004 through interfaces—e.g., web browsers, RESTFul interface and the like. A user/client may request a search 1008—e.g., with or without a number of conditions and/or attributes. For example, search conditions, constraints and/or attributes may comprise one or more of the following: aging, blurring, expression, 3-D models and the like. In reference to the embodiment of FIG. 9, users/clients may request an index of certain data—e.g., structured data, unstructured data, video, image, audio, text or the like. Server/controller may generate a TOC 912 (as described herein) and store the TOC in a set of index tables and/or database 920. The TOC may be displayed back to the user/client 906.

FIG. 10 depicts another embodiment of a suitable system 1000 and processing flow. At a high level, the processing may proceed as: data is input from many possible sources—e.g., imaging sensors (1002), video feed, image feed, audio feed, textual feed external model data (1010), synthetically generated data (1014), and the like. This data and/or media may be ingested and/or indexed (1004). Processed data may be stored in a database (1006)—e.g., into a plurality of formats and structures, for example, TOC, KIT or the like. Searching may be performed on this data (1008)—e.g., as supervised or unsupervised or the like.

Query-by-Example supervised search (1008) proceeds with users/clients search query being ingested/indexed (1004) into the search space SiDb (1006). The search criteria maybe of any form (e.g., image, cropped image, video clip, audio clip, malware, etc.). The indexed signatures of the search criteria are then compared with previously index/stored data (1006) by the similarity search component (SSEC) (1012) to produce a ranked list of results which are passed to the unsupervised search recognition component (RSEC) (1012) which re-ranks the results according to recognition based signatures comparison measures to produce the final rank list of search results which returned to the users/clients through Web-browser or RESTFul interfaces (1016 and 1018).

For additional ingest and/or index processing, many different modules may be applied (as depicted below the dotted line). For example, several external data models may be applied—e.g., A-PIE models (1010) and synthetic models (1014) may be applied. Certain constraints and conditions may be applied and adjusted for—e.g., for example, aging of objects of interest, their pose, expression, orientation, illumination are possible. Additional modules may comprise 3-D modeling, inverse computer generated (CG), synthetic images. In addition, modeling may comprise performing high resolution processing.

For additional search processing, there may be a plurality of searching options (1012)—e.g., similarity search (SSEC) and/or recognition search (RSEC). SSEC is used to produce a rank list of search results based on similarity signature comparison metrics from signatures stored in the SiDb (1006). The similarity search results may optionally be passed to the RSEC and further signature comparison metrics are used to re-rank the similarity results into a new ranked list of search results. This may further comprise truth generators, metric vectors (1014) that may also apply other conditions and/or constraints—e.g., blurring, occlusions, size, resolution, Signal to Noise Ratio (SNR) and the like.

These processes may further comprise a set of analyst modules (1016) to aid in the search and data presentation. For example, data may be subject to various processing modules—e.g., aging, pose, illumination, expressions, 3-D modeling, high resolution models, blurring, occlusion, size, resolution, SNR and the like. Further some of these same processing modules may be applied to advance visualizations and deep analytics (1018) as further described herein.

### One Embodiment of Signature Generation

It will now be described one embodiment of performing signature generation on data—either unstructured or structured. As mentioned herein, a signature is a measure that may be computed, derived or otherwise created from such input data. A signature may allow a search module or routine the ability to find and/or discriminate one piece of data and/or information from another piece of data and/or information. In one embodiment, a signature may be a multivariate measure that may be a based upon information-theoretic functions and statistical analysis.

Some attempts have been made in the art to perform what is known as “sparse representation” as a form of data processing, such as in the following:
(1) United States Patent Application 20140082211 to RAICHELGAUZ et al., published on Mar. 20, 2014 and entitled “SYSTEM AND METHOD FOR GENERATION OF CONCEPT STRUCTURES BASED ON SUB-CONCEPTS”;
(2) United States Patent Application 20140086480 to LUO et al., published on Mar. 27, 2014 and entitled “SIGNAL PROCESSING APPARATUS, SIGNAL PROCESSING METHOD, OUTPUT APPARATUS, OUTPUT METHOD, AND PROGRAM”
(3) United States Patent Application 20140072209 to Brumby et al., published on Mar. 13, 2014 and entitled “IMAGE FUSION USING SPARSE OVERCOMPLETE FEATURE DICTIONARIES”;
(4) United States Patent Application 20140072184 to WANG et al., published on Mar. 13, 2014 and entitled “AUTOMATED IMAGE IDENTIFICATION METHOD”;
(5) United States Patent Application 20140037210 to Depalov et al., published on Feb. 6, 2014 and entitled “SYMBOL COMPRESSION USING CONDITIONAL ENTROPY ESTIMATION”;
(6) United States Patent Application 20140037199 to Aharon et al., published on Feb. 6, 2014 and entitled “SYSTEM AND METHOD FOR DESIGNING OF DICTIONARIES FOR SPARSE REPRESENTATION”;
(7) United States Patent Application 20130185033 to Tompkins et al., published on Jul. 18, 2013 and entitled “UNCERTAINTY ESTIMATION FOR LARGE-SCALE NONLINEAR INVERSE PROBLEMS USING GEOMETRIC SAMPLING AND COVARIANCE-FREE MODEL COMPRESSION”; and
(8) United States Patent Application 20120259895 to Neely et al., published on Oct. 11, 2012 and entitled “CONVERTING VIDEO METADATA TO PROPOSITIONAL GRAPHS FOR USE IN AN ANALOGICAL REASONING SYSTEM”
   all of which are hereby incorporated by reference in their entirety.

In several embodiments disclosed herein, signatures may comprise one or several of the following attributes:
1. Signatures may be high-dimensional, multivariate statistical feature vector representations that quantitatively capture the information content of unstructured data in a compact form and is used to discriminate one piece of information from another.
2. Signatures may represent a reduced form of unstructured data objects:
   a. Unstructured data=image, video, audio, binary data, cyber network traffic, sensor data, communication data, text, IoT/WoT, any raw binary data (e.g., everything in the Digital Universe)
   b. Unstructured data objects=images (e.g., people, vehicles, places, things), audio clips (e.g., voices, music, boats, ships, subs), source code, malware/virus, libraries, executables, network traffic, hard drives, cell phones, RFID, or any other piece of binary data
3. Signatures may be used to quantify and compare the “information content” of data:
   a. The platform supports three major algorithmic operations: Generate signatures. Compare signatures. Link/Crossreference signatures.
4. Signatures may be invariant to:
   a. Rotation, size, (time/space) translation
   b. In addition, signatures may be somewhat invariant to: resolution, noise, illumination, viewing angle
5. Signatures may be N-Dimensional feature vectors:
   a. The major structural components of the signatures capture signal characteristics, information content, spatial frequencies, temporal frequencies. Others may be added.
   b. Signatures may be projected into a high-dimensional space and occupy a position in that N-Dimensional space.
   c. Sets of signatures can be clustered, searched, linked, etc.
   d, Signatures span different data types (i.e., data fusion), language barriers, etc.
   e. Time and geospace may be metadata associated with the signatures and are used to filter the data.
   f. Signatures (in general) are lossy for data reconstruction, but preserve the information content.

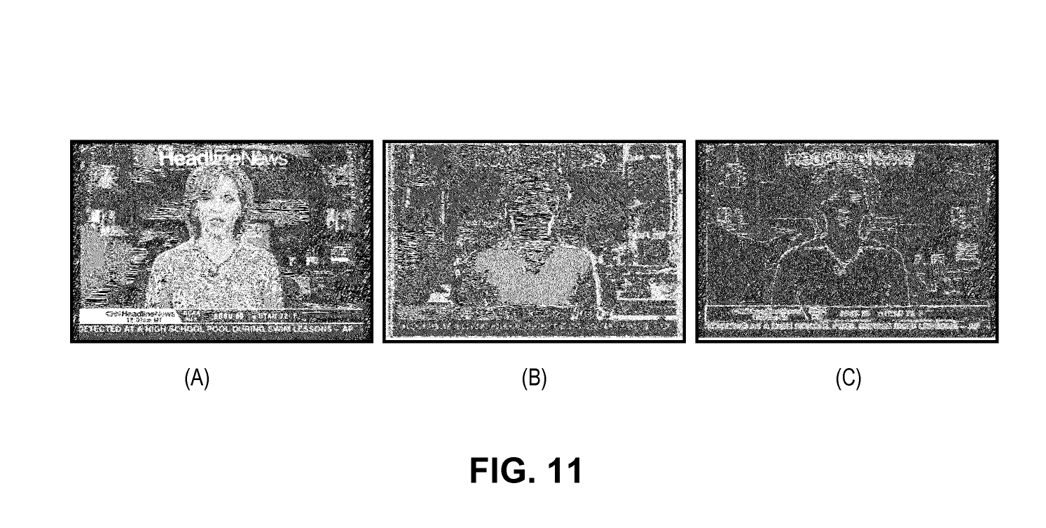

For merely one example, consider the context of processing human faces as depicted in FIG. 11A. Suppose it was desired to generate a signature of the face in FIG. 11A showing one frame of image data—i.e., a female news reporter on a popular news program. Her face may be an object of interest to be searched for within a set of images and/or video—perhaps hours or more of related and/or unrelated video. The image in FIG. 11 may be termed the “native” image or data—as that tends to be the data that is naturally input to the present system for ingest. This native data may be transformed into other complimentary data sets to aid in generating/creating signatures that comprise sufficient detail to allow meaningful distinguishing features to be captured in subsequent searching.

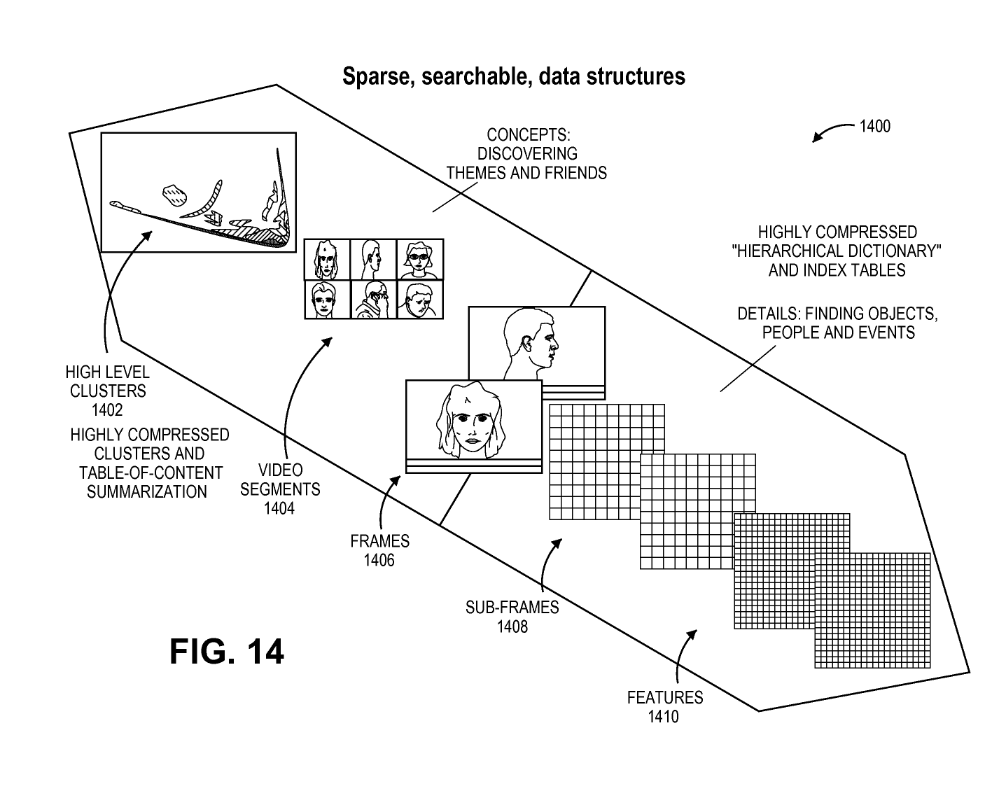

It will also be appreciated that the systems, methods and techniques of generating signatures may be applied to a range and/or hierarchy of data—such that signatures may be generated for specific and/or desired subsets of native data that may be input. For example, FIG. 14 depicts one embodiment of such a hierarchy (1400) of signature data that can be generated using the signature generation algorithms. Video segments 1404 may be input—and signatures may be generated for such video segments. Individual frames 1406 may be of interest—and signatures of such frames may be generated. In addition, subframes 1408—or individual features (e.g., cropped portions or the like) may be of interest—and their signatures may be generated.

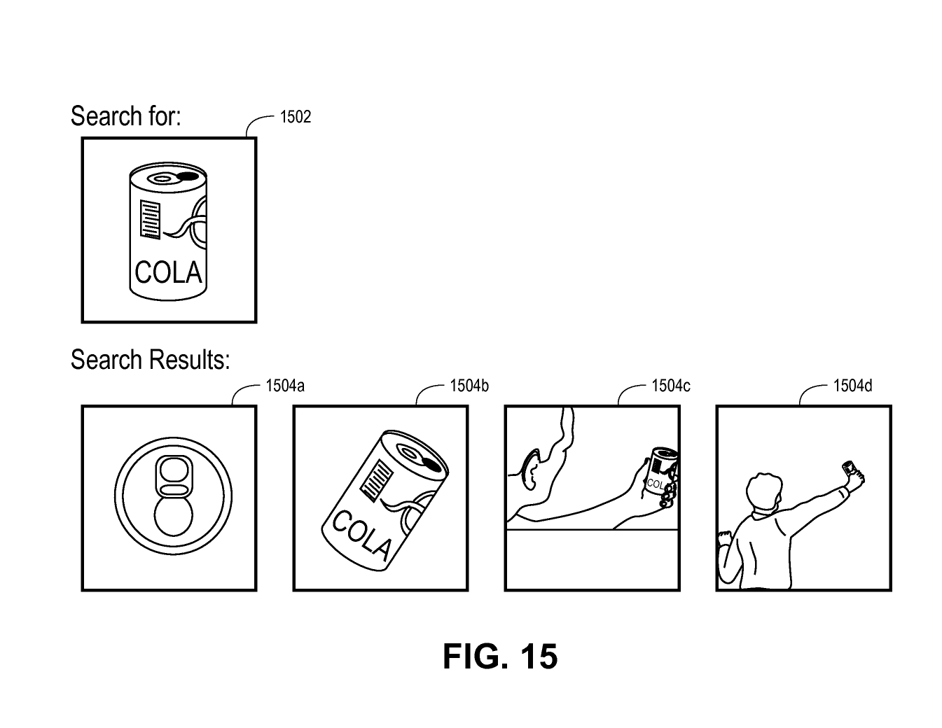

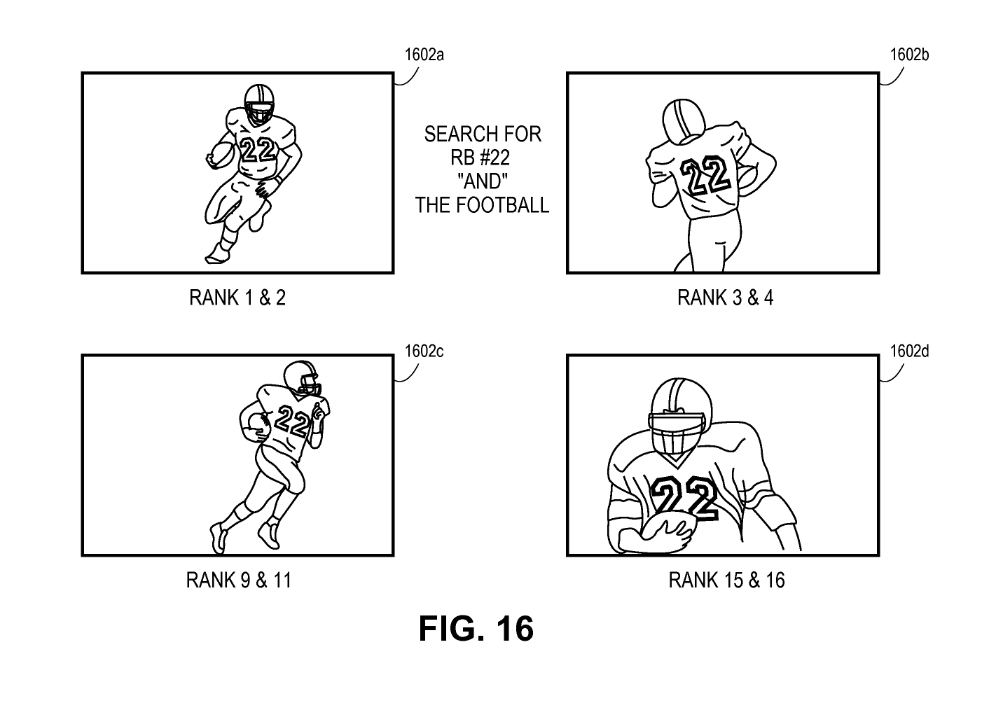

For merely some examples of such granularity, FIGS. 15 and 16 depict two examples of a search for features of interest with a large body of data. FIG. 15 depicts an example search for a cola can (1502) and four search results (1504a-d), where the similarity matches illustrate combinations of size, rotation, orientation, aspect ratio, occlusion, and lighting invariance.

In another example, FIG. 16 depicts example search results (1602a-d) for a football player (#22) and a football, where the search criteria used an “and” boolean clause, such that the football player and the football needed to be present in the frame to be considered a high ranking similarity match. The search results (1602a, b, c, d) depict similarity matches that illustrate combinations of size, rotation, orientation, aspect, occlusion, and lighting invariance.

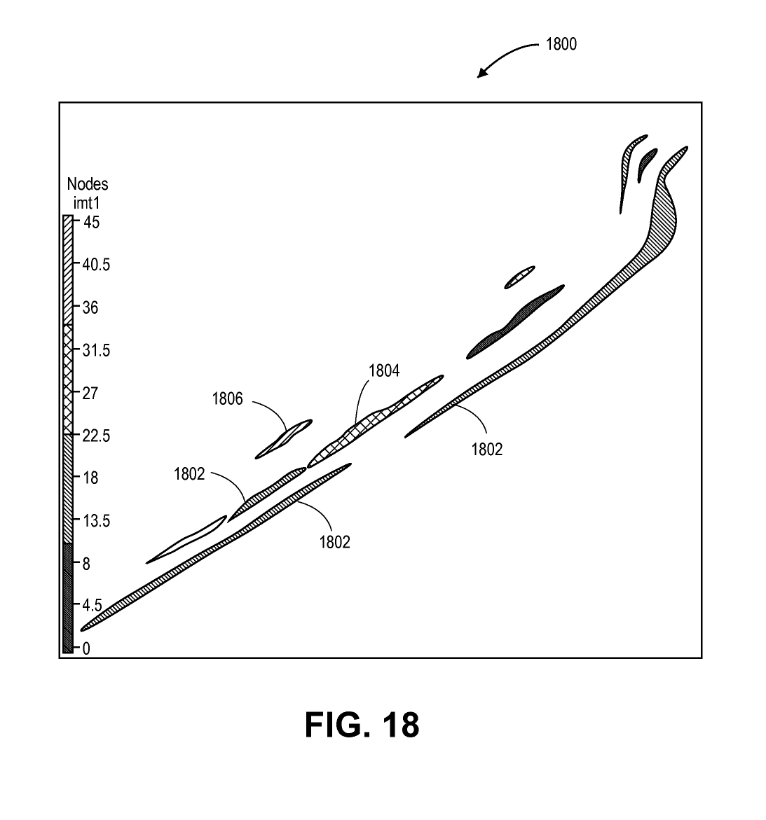

At any level of hierarchy, high level clusters 1402 in FIG. 14 may be generated among signatures of same and/or similar levels may be generated. In one embodiment, high level clusters may be presented in a highly visual fashion—such as depicted in FIG. 18. Plot of clusters 1800 may show individual clusters 1802 through 1806. For one example, these clusters may represent frames that may comprise a scene—e.g., frames that share may similar characteristics and hence “cluster” together. In the context of images, FIG. 18 depicts the distribution of signatures in the search space (1800). The different blobs (e.g., 1802, 1804, 1806) depict clusters of signatures which form blobs, where the signatures associated with the data frames in each blob represent frames of data (images, (cropped) images, video clips, audio clips, etc.) with similar (information) signature content. The source of variation in signature content may be related to size, orientation, aspect, occlusion, lighting, noise, etc.

In other embodiment, these clusters may represent digital data—e.g., applications on a computer system and it may be possible to visually discern malware as a different cluster, depending on some characteristics of its static composition and/or dynamic behavior.

### Embodiments Employing Use of Multiple Transforms

In one embodiment, a signature generation module may be used to generate the composite—e.g., 60-dimensional, signature for any type of data—structured or unstructured. For merely the purpose of exposition, consider the example of the native image given in FIG. 11A as the data of interest to generate a signature. Instead of relying on processing only the native data set, many embodiments of the present application apply one or more transforms to create other data sets that are processed together with the native data set—so as to complement the processing of the native data set.

FIGS. 11B and 11C are two embodiments of transforms of the native image data of FIG. 11A. FIG. 11B depicts the native image data after it has been transform by use of the Shannon Entropy transform. FIG. 11C depicts the native image data after it has been transformed by use of a Difference of Laplacian (DoL) transform. It will be appreciated that other transforms may be employed that either replace these transforms—or augment these transform. For example, other examples of suitable transforms may include: Spectral Frequency, HSI (Hue, Saturation, and Intensity), DoG (Difference of Gaussians), HoG (Histogram of Oriented Gradients. Other transforms may also suffice. It may be desired that whatever transform is employed that it aids in distinguishing features—one from another—and, in particular, transforms that aid human sensory system are suitable.

The use of the Shannon Entropy transform tends to apply a logarithmic process to the native image data. This transform substantially tends to emulate human sensory data processing—e.g., where the human visual system and the human auditory system have a logarithmic response curve. Applying an entropy-like transform to a native data set may tend to aid in identifying features to which humans tend to pay attention become more distinguishable from noise. Like use of an entropy-like transform, the use of the DoL transform tends to make edges, corners, curvatures and the like more distinguishable in an image.

In the example of the three images in FIG. 11A-C, each image may contribute a portion of the composite signature. The transform used to produce FIG. 11B brings signature features out of the noise using a Logarithmic function of the data. The transform used to produce FIG. 11C accentuates features similar to those used by the human vision system (e.g., edges, curvature, and corners).

One embodiment for the generation of signatures for desired data sets may proceed as follows:
1. Native data sets may be input into the system.
2. Native data sets may be transformed into new data sets using various transforms—e.g., Shannon Entropy, entropy-like transforms, DoL and the like.
3. The native data sets and the transformed data sets may be processed to compute feature vector components by breaking and/or partitioning each data set up into its spectral components and computing two low-order statistical moments and three higher-order statistical moments.
4. For input data that is not image data (e.g., audio, text, malware or the like), the input data may be transformed into a spectrogram and represented as a new native data sets (e.g., similar to image data that may have spectral components). A FFT may be used to transform the data into a frequency vs. time spectrogram. Time may be the relative position within the frame data. Processing may then proceed similar to steps 1-3 above.

As mentioned, several embodiments employ up to 5 statistical moments. These moments may include the mean, variance, skew, kurtosis and hyperskew, as are known in the art.

Returning to the example of FIGS. 11 A-C, the native data set of FIG. 11A may be transformed by an entropy-like transform as follows:
1. The native image may be placed into a histogram:

$$Histogram = {Bin}_{j} = {\sum }_{i = i}^{n} ( {Bin}_{{x}_{i}} + 1 ) , where {Bin}_{j = 0 , 255}$$

2. Each histogram may be normalized into a Probability Distribution Function (PDF):

PDFⱼ=Bin^{j}/n, j=0,255
3. Replace each data point with a P*log P value:

xᵢ=PDFₓ_{ᵢ}*log₈PDFₓ_{ᵢ}, i=1,n
4. Thereafter, this transformed set may be processed with by the 4 spectral components and the 5 statistical moments, as noted.

Returning to the example of FIGS. 11 A-C, the native data set of FIG. 11A may be transformed by an DoL-like transform or any other suitable spatial frequency transform (e.g., Difference of Gaussian-DoG or the like) as follows:

$${I}_{{x}_{i}} - Laplacian DOL = {I}_{{x}_{i}} - {\sum }_{j = 1}^{m} {x}_{j}$$

where m=number of nearest neighbors. Thereafter, this transformed set may be processed with by the 4 spectral components and the 5 statistical moments, as noted.

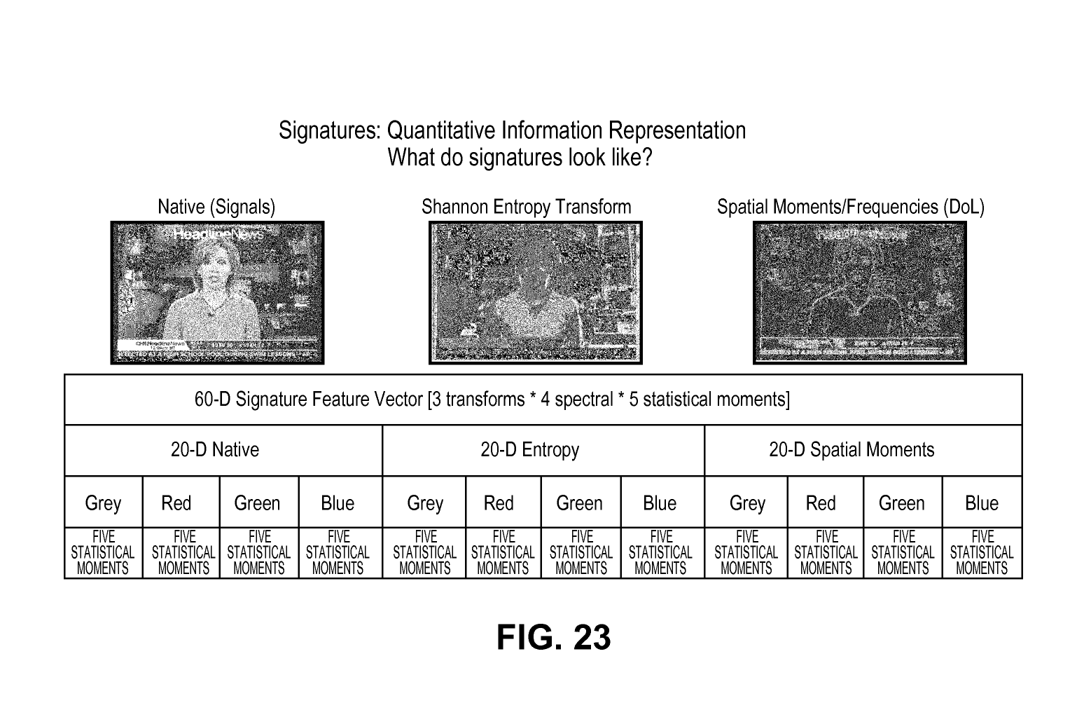

FIG. 23 depicts the native data set and two associated transform data sets as then processed as disclosed—e.g., to produce a 60-D signature vector.

### One Signature Dope Vector Embodiment

After the processing is complete on the native data set FIG. 11A and the two transformed data sets, FIGS. 11B and 11C, the following is one exemplary signature dope vector that may be generated:
Signature Dope Vector: 0000151 0000060 V:20#E:20#S:20#66.26 57.48 0.66 2.45 0.11 91.74 91.30 0.69 1.98 0.17 54.79 51.54 1.02 3.72 0.15 53.18 50.71 1.23 4.35 0.14 35.48 64.87 2.99 10.28 0.00 59.96 94.99 1.35 2.91 0.00 42.96 80.05 2.24 6.12 0.00 42.56 80.25 2.25 6.12 0.00 18.73 30.63 3.04 13.10 0.20 19.43 33.17 3.09 13.80 0.22 18.90 31.74 3.05 13.20 0.20 18.84 29.10 2.91 12.58 0.19

In this embodiment, the composite signature based on these transformations for the data shown in FIGS. 11A-C is represented as a row vector with 60 columns, which row vector contains three groups of 20 numbers, where each successive group of 20 numbers is associated with the transforms shown in FIGS. 11A-C. Each group of 20 numbers is broken down into four groups (spectral components—Grey, Red, Green, Blue for these examples) with five statistical moments (mean, variance, skew, kurtosis, hyperskew) each—e.g., 3 transform groups*4 spectral components*5 statistical moments=3*20=60 signature features for each signature feature vector.

The complete composite signature associated with FIGS. 11A-C is “66.26 57.48 0.66 2.45 0.11 91.74 91.30 0.69 1.98 0.17 54.79 51.54 1.02 3.72 0.15 53.18 50.71 1.23 4.35 0.14 35.48 64.87 2.99 10.28 0.00 59.96 94.99 1.35 2.91 0.00 42.96 80.05 2.24 6.12 0.00 42.56 80.25 2.25 6.12 0.00 18.73 30.63 3.04 13.10 0.20 19.43 33.17 3.09 13.80 0.22 18.90 31.74 3.05 13.20 0.20 18.84 29.10 2.91 12.58 0.19”. It should be noted that resolution of the numbers has been rounded to two decimal places for inclusion into this document; the applications make use of all available decimals represented in binary real number representation), where:
(1) the first 20 numbers (“66.26 57.48 0.66 2.45 0.11 91.74 91.30 0.69 1.98 0.17 54.79 51.54 1.02 3.72 0.15 53.18 50.71 1.23 4.35 0.14”) are associated with the “Native Statistics”
(2) the second 20 numbers (“35.48 64.87 2.99 10.28 0.00 59.96 94.99 1.35 2.91 0.00 42.96 80.05 2.24 6.12 0.00 42.56 80.25 2.25 6.12 0.00”) are associated with the “Entropy”
(3) and the third 20 numbers (“18.73 30.63 3.04 13.10 0.20 19.43 33.17 3.09 13.80 0.22 18.90 31.74 3.05 13.20 0.20 18.84 29.10 2.91 12.58 0.19”) are associated with the “Spatial Frequencies”,

It will be appreciated that any other number of suitable spectral components may be used other than 4—e.g., for example, in multi-spectral or hyper-spectral data. In addition, it will be appreciated that any number of statistical measures and/or moments may be employed other than 5. In addition, other embodiments may employ other and/or different transforms to the native data set.

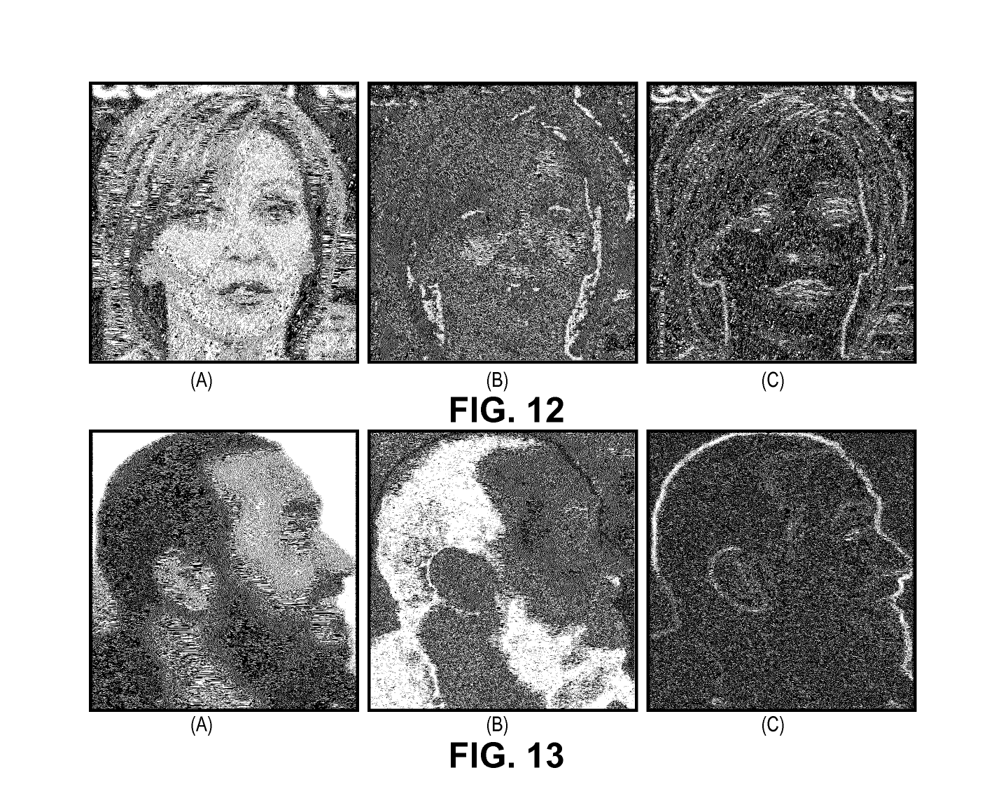

In operation, the system ingests a number of data sets and signatures are generated and stored. For example, FIGS. 12A-12C and 13A-13C may comprise different data sets that are transformed and processed as described and their signatures are stored for subsequent searching. In fact, FIGS. 12A-C and 13A-C depict that images may be initially cropped in order to focus in on an object of interest.

Non-Image Data Signature Generation

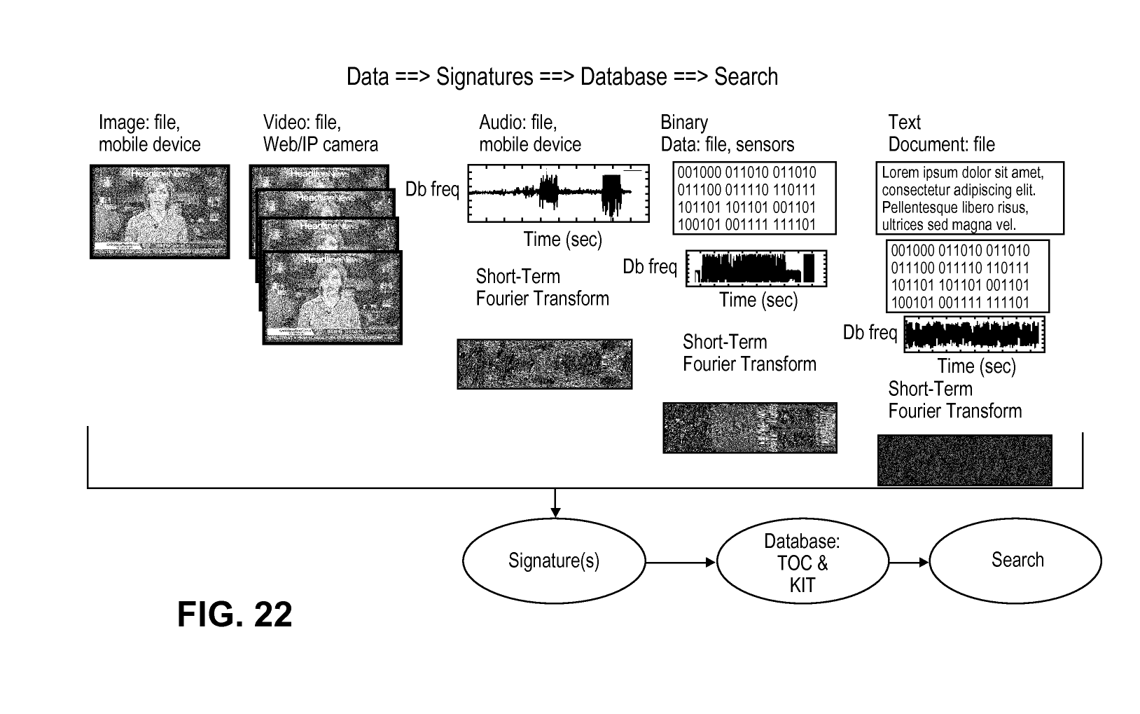

Any type of digital, binary data can be transformed into data frames which can then be transformed into signatures. FIG. 22 depicts these various categories of data that may be processed in accordance with the principles of the present application:

Images: Images may be used as data frames. Signatures for each data frame and hierarchical sub-data frames may be generated using the algorithms described herein.

Video: Video may be decomposed into sequences of data frames. Signatures for each data frame and hierarchical sub-data frames may be generated using the algorithms described herein.

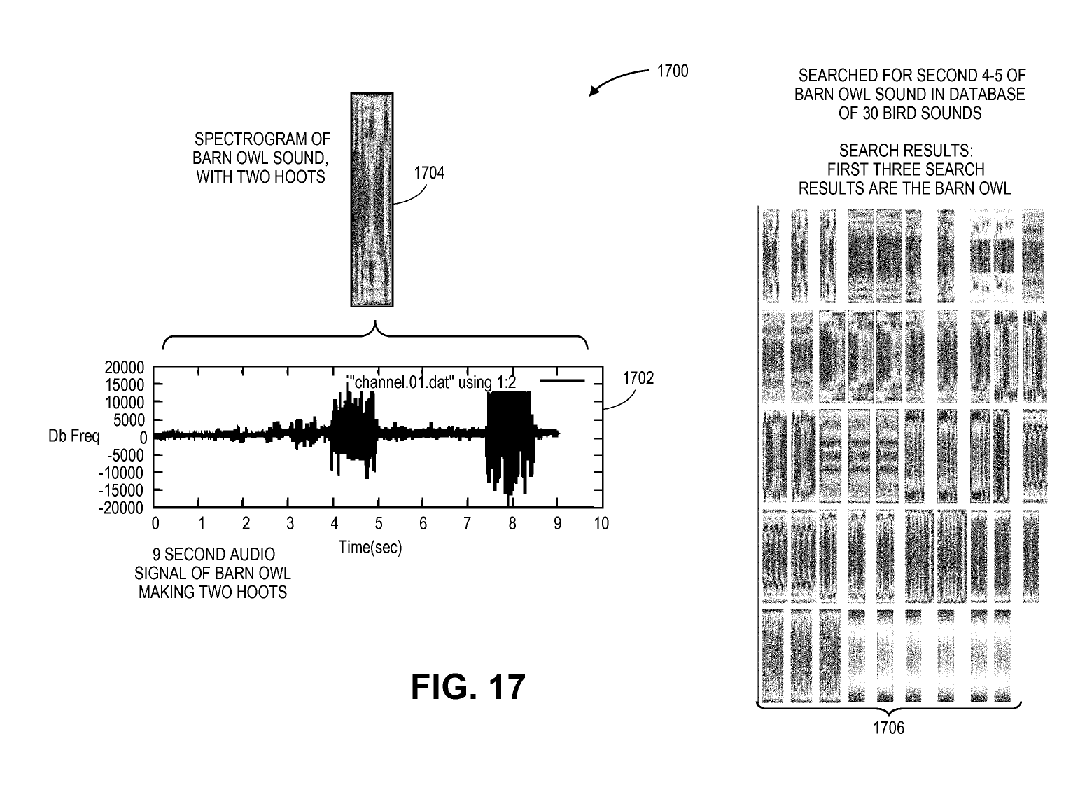

Audio: Audio may be represented as an amplitude vs. time digital signal. A Short Time FFT (STFT) (or any other suitable Fourier transform) algorithm may be used to transform the signal into sequences of spectrograms using a sliding, overlapping window. The spectrograms may then be used as the data frames. Signatures for each data frame and hierarchical sub-data frames may be generated using the algorithms described herein. FIG. 17 depicts one example of search results when searching for a specified audio signal, where this audio recorder contains two hoots from an owl between ˜4.0-5.0 sec and ˜7.5-8.5 sec in 1702. The signature generation techniques described herein may generate a spectrogram 1704 of the audio data. Such spectrogram and/or signature may form the search criteria and the matrix of ranked search results are depicted in 1706.

Raw binary data: Raw binary data may be represented as an amplitude vs. time digital signal, where the relative position within the data takes the place of time. A Short Time FFT (STFT) algorithm may then be used to transform the signal into sequences of spectrograms using a sliding, overlapping window. The spectrograms may then be used as the data frames. Signatures for each data frame and hierarchical sub-data frames may be generated using the algorithms described herein.

Text: Text may be represented as an amplitude vs. time digital signal, where the relative position within the binary representation of the text data takes the place of time. A Short Time FFT (STFT) algorithm may then be used to transform the signal into sequences of spectrograms using a sliding, overlapping window. The spectrograms may then be used as the data frames. Signatures for each data frame and hierarchical sub-data frames may be generated using the algorithms described herein.

### Table of Contents (TOC) Generation Embodiments

Once signatures are generated, they may be stored and/or indexed in a Table of Contents (TOC). In one embodiment, the TOC may be construed as a temporal summarization of the unstructured data that compresses out the redundancy in time, space, and information content of the signatures by using time-series analysis algorithms described in the workflow, below.

The TOC may be analogous to a chapter index in a typical book, where the content of the book is summarized into segments of common content. TOC segments may be analogous to chapters of a book. The segments may sequentially progress from start to end of the data along a time axis, where the time axis can be real human-time or a time axis generated by using the relative position within the data.

The TOC may be created as part of the indexing process and is one of the three primary data structures that compose the search space representation, where the signatures and the KIT (as described herein) may be the other two major data structures. The TOC summarizes the unique spatial/temporal information content of the unstructured data. The TOC is built by performing a time-series analysis of the signatures. The KIT is derived from the TOC entries.

The following is one embodiment describing the generation of the TOC:
1. Signatures may be sorted into a time series by data frame number.
2. Time series may be analyzed to find discontinuities by computing and comparing the signature comparison metric from successive signatures to a running average signature. Discontinuities may be labeled by sequentially incrementing a segment counter.
3. Segments may be formed by noting the beginning and ending data frame numbers between successive discontinuities. Segment signatures may be computed by averaging the signatures of the data frames within each segment. The segment keyframe may be located as the data frame signature closest to the average segment signature using the signature comparison metric. A segment dope vector may be formed, comprising: starting data frame, ending data frame, number of frames in the segment, segment keyframe, and URI to the data frame in the original data.
4. The collection of segment dope vectors is called the TOC data structure.
5. The TOC may be stored into the SiDb into a target database.

### Keyword Index Table (KIT) Embodiments

As mentioned, the KIT may be employed as one of the primary data structures stored in the SiDb database. The structure of the KIT may look a lot in structure like the index table in the back of a typical book which cross-references keywords and their location through the document(s), where the most left-hand entry is called a “keyword” and column entries are called “entities”.

The KIT may be constructed as an inverted index table, also referred to as a Sparse Representation Dictionary, created by the indexing process using Sparse Representation algorithms. The size of the KIT (i.e., number of entries and storage requirements) may scale according to the amount of unique information content (e.g., number of subjects) contained in the unstructured data, not the volume of the data or the number of images/frames.

Generating the KIT may proceed as an indexing process that hierarchically decomposes frame data using a sliding overlapping spatial/temporal window which is swept across the frame, where each window is referred to as an “entity”. This may emit a data structure of “documents pointing to entities”. When this data structure is “inverted”, to generate an inverted index table, it may emit a new data structure of “entities pointing back into documents” which is used as the primary searchable data structure to support keyword searches. Entities may be filtered into a set of “unique” entities, called keywords, by “binning” the entities according to the signature comparison metric; where a keyword represents a “bin” of entities.

In one embodiment, a keyword may represent a truncated, high-dimensional cone in the search space whose dimensions are defined by the entities associated with the keyword on any given row of the KIT dictionary. The entities associated with each keyword may be the entities which have (coordinate) signatures contained inside the keyword-cone. Each keyword is a new row in the KIT dictionary, where the column entries on each row are the entities contained in the keyword-cone. The signature of the keyword on a row of the KIT is the most average (signature) entity within the row. This may employ an iterative algorithm to achieve the optimal KIT.

When all of the keywords from the KIT are assembled, they may form the semi-orthogonal information basis vector that spans the information content of the unstructured dataset, where the information content of the original dataset can be reconstructed from the KIT by reassembling the entities back into frame data. The basis vector may be semi-orthogonal because the bins used to generate the KIT may overlap.

The following may be one embodiment for generating a KIT:
1. The KIT may be a row-column data structure, where the first entity of the row represents unique keyword and the column entries are successive occurrence of the entity within the unstructured data which may be associated with a keyword based on the signature comparison metric. The KIT may be formed by looping over the TOC segment keyframes:
   a. Each segment keyframe may be decomposed at successively smaller spatial/temporal scales using sliding, overlapping sub-frame windows. Each sub-frame window is called an entity.
   b. The frame data within each entity may be used to generate entity signatures.
   c. Each new entity signature is compared to all of the KIT dictionary signatures, using the signature comparison metric, and only stored as a keyword in the KIT if it is unique (e.g., if it already doesn't exist in the dictionary). It should be noted that at the beginning the KIT dictionary may be empty so the first entity is placed into the KIT as the first keyword. If the entity does exist as a keyword in the KIT, the entity is added as a new column entry to the row associated with the keyword.
2. A KIT dope vector for each row of the KIT dictionary may be formed that contains the signature/name of the keyword, the signatures/names of the entities, the geometry of the keyword/entities.
3. The set of KIT dope vectors may be stored into a data structure called the KIT dictionary.
4. The KIT dictionary may be stored into the SiDb into a target database.

### Searching Embodiments

As mentioned, searching for objects of interest in unstructured data may proceed as a distance and/or metrics comparison on signatures of the object of interest against those signatures stored in databases.

In one embodiment, supervised searches may proceed as QBE searches. The QBE query is ingested, indexed, and stored. The signature of the query may be compared with a specified subset of signatures stored in the SiDb and a result search page of ranked results may be returned. The QBE query can be user specified (i.e., human-to-machine) or machine generated (machine-to-machine) by using mobile devices, desktops, recording devices, sensors, archived data, watch lists, etc.

Some exemplary applications may comprise: (1) Generalized query-by-example (i.e., search for anything); (2) Patterns-of-Life (compound or complex searches using “and”, “or”, “not”) and/or (3) Digital Rights Management, Steganography. It will be appreciated that many other possible searching applications and embodiments are possible.

One embodiment of a searching processing and/or module may proceed as follows:
1. Ingest search query data.
2. Generate signature, TOC, and KIT.
3. Store into SiDb.
4. Select target signature databases to compare to any specified signature and/or “all” signatures.
5. Compare source signature(s) with target signatures from the SiDb to generate [distance metrics, signature] key-value pairs using the signature comparison metric.
6. Sort the key-value pairs based on the distance metric; smallest to largest.
7. Select the top-N sorted key-value pairs as the ranked search results.
8. Format top-N ranked results into a SERP.
9. Return SERP as:
   a) HTTP Web page result.
   b) Posted REST Services SERP.

### Embodiments of Unsupervised Search

In several embodiments employing unsupervised search, tables of auto-nominated keywords (e.g., called Sparse Representation dictionaries) may be generated as inverted index tables. An inverted index table may be a matrix of row/column <key, value> pairs, where the “key” is a keyword signature and the “value” is the list of entity signatures associated with the keyword for the row. The keyword for the row is the entity signature that is closest to the average row's entity signature based on the signature comparison metric. The keyword and entities on a given row share similar information content and are technically interchangeable. Some exemplary applications may comprise: (1) Social network analysis (Facebook or Linkedin for everything); (2) Patterns-of-Life; (3) Link analysis: Finding ring leaders, thought leaders, organizers; and/or (4) Multi-Source data fusion.

One possible embodiment for processing may proceed as follows:
1) Indexing Workflow
   Ingest data
   Generate signatures
   Generate TOC
   Generate KIT
   Store signatures in signature database (SiDb)
2) Unsupervised Search Workflow
   Retrieve KIT from SiDb
   Return KIT as Search Engine Result Page (SERP)

### Embodiments for Comparing Signatures

In many embodiments, the distance between two signature feature vectors may be computed. Signatures may be compared in a pairwise fashion based on a distance metric. For example, there are three possible options for metric distance measures given below.
1) L̂1-norm (e.g., Taxicab or Manhattan distance):

sum(|X(j)−X(i)|)
2) L̂2-norm (e.g., Euclidean distance):

sqrt(sum((X(j)−X(i))*(X(j)−X(i))))
3) Cosine-distance:

angle=arccos(dot(X(j),X(i))/(|X(j)|*|X(i)|)

It will be appreciated that other distance formulas and/or metrics may be suitable for the purposes of the present application.

### Search Space Embodiments

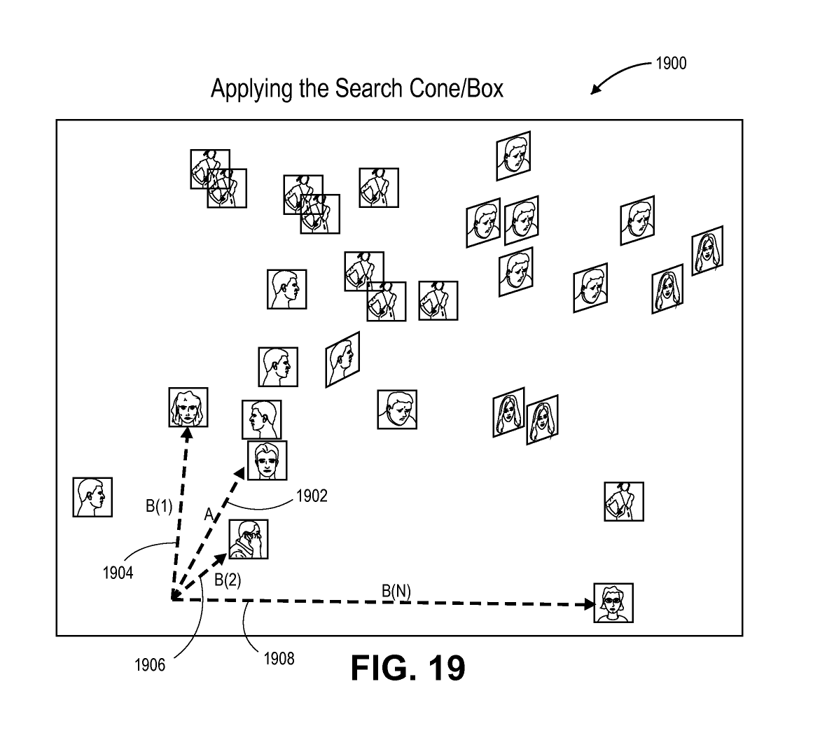

FIG. 19 depicts the search results as a search space (1900) and the distribution of signatures associated with a prototypical ranked list of search results. As may be seen, vector A (1902) depicts the signature feature vector associated with the exemplar search criteria and the vectors B(1), B(2) through B(N) (1904, 1906, through 1908) depict the signature feature vectors of the closest N-search results, where the ranking may be determined by a high-dimensional metric distance measure.

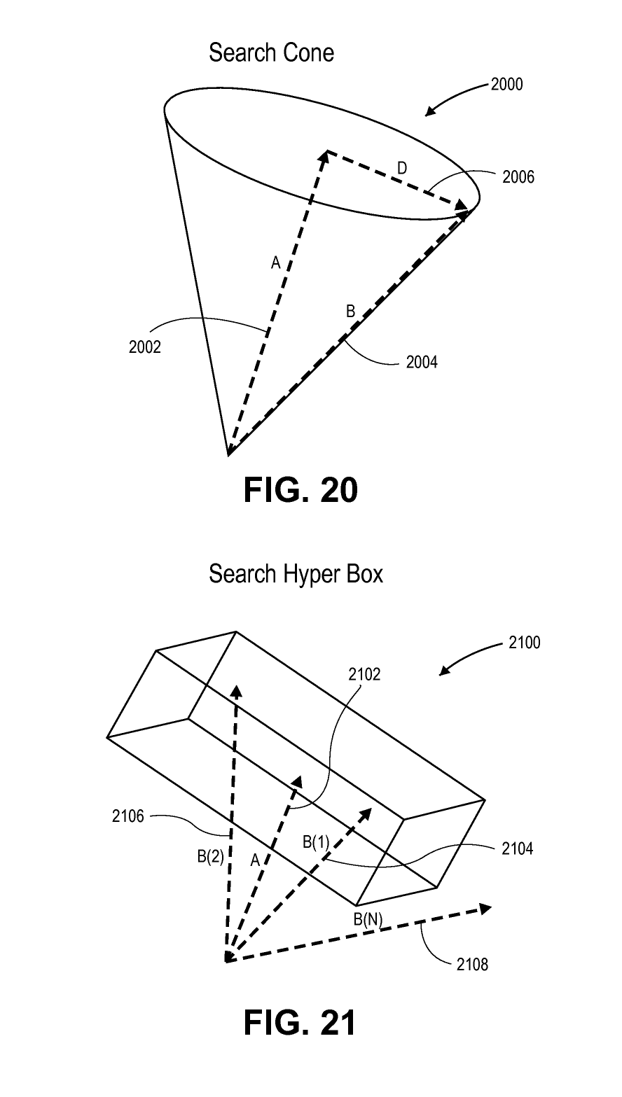

FIGS. 20 and 21 depict two exemplary measures that may comprise the high-dimensional distance metric. In one embodiment, FIG. 20 represents a search cone and FIG. 21 depicts a hyperbox, which surrounds the search criteria, used as subsets of the high-dimensional space, such that substantially only the signatures contained within the cone and/or hyperbox may be considered candidate similarity matches. This type of algorithm may be used to reduce the population of candidates similarity matches, thereby reducing the false positives and reducing the computation processing cost for later phases of the search process.

In another embodiment, FIG. 21 depicts the calculation of the search space metric (2000). The final distance measure (2006) calculation is used to compare the two signature feature vectors (2002 and 2004). In referring back to FIG. 19, the signature feature vector A may be compared to the all of the signature feature vectors B by computing a metric distance (2006). This collection of metric distance measures may then be ranked according to magnitude (smallest to largest) and may be returned as the search results ranked list.

### Synthetic Ground Truth Generator Embodiments

In many embodiments, a synthetic ground truth generator (SGTG) may be employed to provide additional verification, validation, and uncertainty quantification capabilities to explore all possible unstructured data combinations along metric vectors which span the information space associated with the unstructured data. In one embodiment, the SGTG may be a test harness which performs sets of unit tests that generate synthetic data, input it into the search engine platform, execute the search engine algorithms, and evaluate the results to quantify how well the search engine platform performs on any given dataset. The SGTG loop is depicted in FIG. 10 as 1014, 1006, 1008, 1012 loop. Suitable applications may comprise: (1) Exhaustively explore the parametric signature search space to evaluate the accuracy of the search platform algorithms and (2) Provided levels of confidence measures based on the quality, resolution, noise level, etc. of the ingested data.

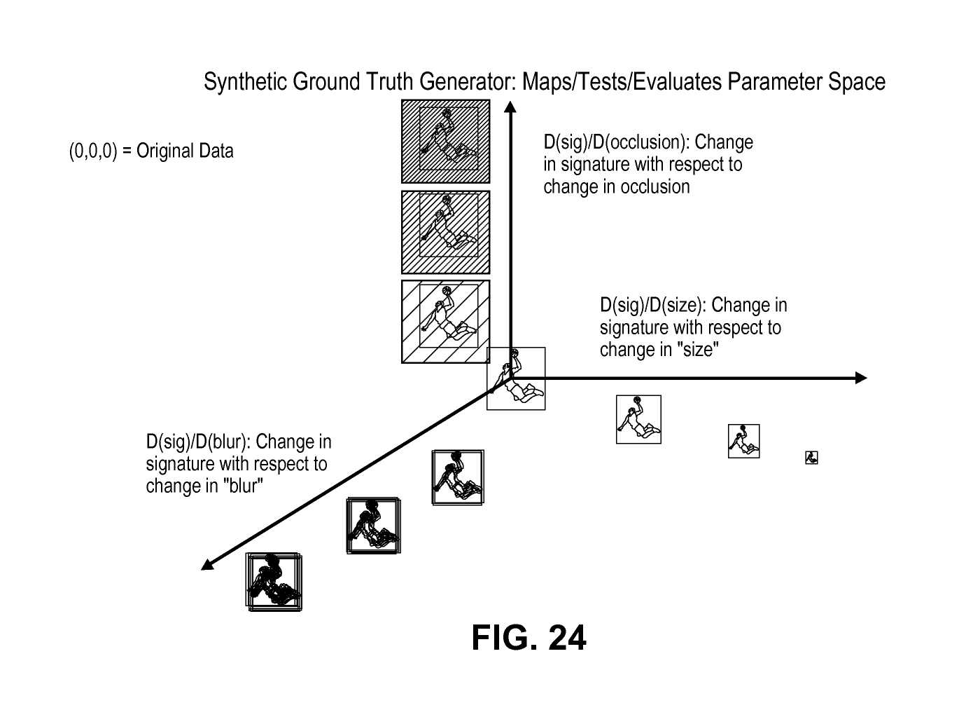

FIG. 24 depicts one possible embodiment of a SGTG in operation. Starting with an input data set (e.g., the image at the origin), the data set may be “tested” and/or transformed with respect to various different characteristics—e.g., changes in size, blurring and/or occlusion. As the native and/or original data set is changes on any given axis, new signatures may be generated and tested against a database. Any features that tend to be invariant with respect to these characteristics may tend to aid in locating objects of interest in the database. The capabilities demonstrated and quantified by the SGTG for systematic variation of scene conditions (e.g., size changes, blurriness, levels of occlusion) are demonstrate in the robustness of the search example in FIG. 15 which depicts the search of a cola can 1502 and the search matches that include size variation 1504c and 1505d; rotations 1504a and 1504b; and occlusion by a person's hand 1504c and 1504d.

### Embodiments of Search as Web Service

In one embodiment, systems and methods of the present application may be provided as Web Services. Such Web Services may provide the human-to-machine or machine-to-machine interface into the search engine platform using a client/server architecture. Web Services may also provide the basis for a services-oriented-architecture (SoA), software-as-a-service (SaaS), platform-as-a-service (PaaS), computing-as-a-service (CaaS). The clients can be thin, thick, or rich. The structure of the web services architecture may be LAMPP: Linux, Apache, MySQL, PHP, Python—e.g., which calls into the search engine platform algorithms to input information, computing results, and return results as SERPs. The web server may make heavy use of HTML5, PHP, JAVASCRIPT, and Python.

Some exemplary applications may comprise: (1) Generalized supervised search engine (i.e., a Google-like search engine for searching for anything in anything); (2) Generalized unsupervised search engine (i.e., a Facebook/Linkedin social networking/link analysis engine for everything) and/or (3) Generalized object editing.

One embodiment of a suitable web service process may proceed as follows:

1) From a Web-based client, the following processing may occur:
Ingest Data
Process Data based on input requests
   Index
   Supervised Search
Output Results based on input requests
   TOC SERP
   KIT SERP
   Search SERP

2) From a RESTFul client, the following processing may occur:
Ingest Data
Process Data based on input requests
   Index
   Supervised Search
Output Results based on input requests
   TOC SERP
   KIT SERP
   Search SERP

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A system for searching digital data, comprising:
an indexing module, said indexing module capable of receiving a native digital data set, said native digital data set comprising a spectral distribution;
a signature generation module, said signature generation module capable of generating one or more transform data sets from said native digital data set and generating a signature vector from said native digital data set and one or more transform data sets, said signature vector comprising a spectral decomposition and a statistical decomposition for each of said native digital data set and one or more transform data sets;
a TOC database, said TOC database capable of storing said signature vectors; and
a searching module, said searching module capable of receiving an input signature vector, said input signature vector representing an object of interest to be searched with said TOC database and return a set of signature vectors that are substantially close to said input signature vector.

2. The system of claim 1 wherein said indexing module further comprises:
an unstructured data indexing module, said unstructured data indexing module capable of receiving an unstructured native digital data set and generating a set of related data segments, said related data segments comprising substantially similar information content.

3. The system of claim 2 wherein said related data segments are determined by scanning signature vectors of said unstructured native digital data and determining discontinuities, said discontinuities marking the end of a related data segment.

4. The system of claim 1 wherein said indexing module further comprises:
a non-image digital data indexing module, said non-image digital data indexing module capable of receiving non-image digital data and capable of generating an associated spectrogram from said non-image digital data; and capable of generating a signature vector for said non-image digital data from said associated spectrogram.

5. The system of claim 4 wherein said non-image digital data indexing module further capable of generating an amplitude vs time digital signal from said non-image digital data; and capable of applying a Fourier transform to said amplitude vs time digital signal to generate a spectrogram.

6. The system of claim 5 wherein said non-image digital data comprises one of a group, said group comprising: audio, text, binary data, malware.

7. The system of claim 1 wherein said signature generation module further capable of applying an entropy-like transform to said native digital data set.

8. The system of claim 7 wherein said entropy-like transform further comprise a Shannon entropy transform.

9. The system of claim 7 wherein said signature generation module further capable of applying a spatial frequency transform to said native digital data set.

10. The system of claim 9 wherein said spatial frequency transform comprises one of a group, said group comprising: Spectral Frequency, HSI (Hue, Saturation, and Intensity), DoG (Difference of Gaussians), DoL (Difference of Laplacian), HoG (Histogram of Oriented Gradients).

11. The system of claim 10 wherein said signature generation module is further capable of applying a plurality of N statistical moments to a plurality of M partitions of spectral components of each native digital data set and each transform data set to generate a signature vector.

12. The system of claim 11 wherein said statistical moments further comprise one of a group, said group comprising: mean, variance, skew, kurtosis and hyperskew.

13. The system of claim 1 wherein said TOC database is further capable of sorting said signature vectors into a time series by data frames numbers; analyzing said time series to find discontinuities; forming segments of data frames by noting the beginning and ending data frame numbers between said discontinuities; forming segment vectors and storing segment vectors into the TOC database.

14. The system of claim 1 wherein said system further comprises:
a synthetic ground truth generator (SGTG), said SGTG capable of generating synthetic data; inputting said synthetic data into said searching module and evaluating the results of searching for said synthetic data.

15. The system of claim 14 wherein said synthetic data comprises a transformation of an original data set according to a characteristic.

16. The system of claim 15 wherein said characteristic comprises one of a group, said group comprising: size, blurring, occlusion, aging, pose and expression.

17. A method for generating signature vectors from a native digital data set, comprising:
receiving a native digital data set;
applying an entropy transform to said native digital data set to create an entropy data set;
applying a spatial frequency transform to said native digital data set to create a spatial frequency data set;
partitioning each of said native digital data set, said entropy data set and said spatial frequency data set into a set of spectral component data sets; and
applying a set of statistical moments to said spectral component data sets to create a signature vector for said native digital data set.

18. The method of claim 17 wherein if said received digital data set is non-image digital data, creating an amplitude vs time data set and generating a spectrogram from said amplitude vs time data set to create a native digital data set.

19. The method of claim 17 wherein said entropy transform comprises a Shannon entropy transform.

20. The method of claim 17 where said spatial frequency transform comprises one of a group, said group comprising: Spectral Frequency, HSI (Hue, Saturation, and Intensity), DoG (Difference of Gaussians), DoL (Difference of Laplacian), HoG (Histogram of Oriented Gradients).

21. The method of claim 17 wherein said set of statistical moments comprises one of a group, said group comprising: mean, variance, skew, kurtosis and hyperskew.

22. The method of claim 17 wherein said method further comprises:
sorting said signature vectors into a time series by data frame number;
analyzing said time series to find discontinuities;
forming segments of data frames by noting the beginning and ending data frame numbers between said discontinuities; and
forming segment vectors from said segments.
